(19) United States
(12) Patent Application Publication
(10) Pub. No.: US 2025/0128621 A1
(43) Pub. Date: Apr. 24, 2025

(54) POWER SYSTEM

(71) Applicant: HONDA MOTOR CO., LTD., Tokyo (JP)

(72) Inventors: Seiichiro KONDO, Tokyo (JP); Yuta SATO, Tokyo (JP)

(21) Appl. No.: 18/925,058

(22) Filed: Oct. 24, 2024

(30) Foreign Application Priority Data
Oct. 24, 2023 (JP) 2023-182545

(51) Int. Cl. B60L 53/22; B60L 50/60

(52) U.S. Cl. CPC B60L 53/22; B60L 50/60; B60L 2200/10; B60L 2200/12; B60L 2210/12; B60L 2210/14; B60L 2210/30; B60L 2210/40

(57) ABSTRACT

A power system includes a control device configured to operate a DC-DC converter and a power converter. The control device performs bulk voltage control by operating a voltage converter under a power feeding mode and performs the bulk voltage control by operating a power converter under a charging mode and a power feeding during charging mode. When the control mode is switched between the power feeding mode and the power feeding during charging mode according to a charging and power feeding request being acquired, from when the charging and power feeding request is acquired until an operation target of the bulk voltage control is switched between the DC-DC converter and a half PFC circuit of the power converter, the control device boosts or steps down a bulk voltage by a predetermined amount from a point in time when the charging and power feeding request is acquired.

This application is based on and claims the benefit of priority from Japanese Patent Application No. 2023-182545, filed on 24 Oct. 2023, the content of which is incorporated herein by reference.

### FIELD OF THE INVENTION

The present invention relates to a power system. More specifically, the present invention relates to a power system that can simultaneously perform charging to an electrical storage device with an external power supply connected to an inlet and power feeding to an external load connected to an outlet.

### RELATED ART

In recent years, in order to enable more people to secure access to reasonable, reliable, sustainable, and advanced energy, research and development has been conducted into charging and power feeding in mobility vehicles equipped with secondary batteries that contribute to energy efficiency.

Patent Document 1 discloses a vehicle power control device including a storage battery mounted on a vehicle, a charging terminal connectable to an external AC power supply, a charging device that converts AC power input from the charging terminal into DC power to charge the storage battery, a discharge terminal to which an external AC load is connectable, and a power feeding device that converts the DC power from the storage battery into AC power and outputs the AC power from the discharge terminal. With the vehicle power control device disclosed in Patent Document 1, it is possible to feed power to the AC load while charging the storage battery by connecting the external AC power and the external AC load respectively to the charging terminal and the discharge terminal. Therefore, it is possible to improve convenience of a user.
Patent Document 1: Japanese Patent No. 5578209

### SUMMARY OF THE INVENTION

Incidentally, in order to stably perform the charging to the electrical storage device and the power feeding to the external load, it is necessary to perform voltage control for maintaining, at a predetermined voltage, a voltage of a bulk capacitor included in a power circuit that connects the electrical storage device and the inlet and the outlet. The voltage control for the bulk capacitor is often performed by operating, with a control device, various converter circuits connected to the bulk capacitor.

Since a flow of power in the power circuit differs between that during charging and that during power feeding, for example, if it is attempted to start charging while power is being fed, it is necessary to switch the converter circuit operated to perform the voltage control for the bulk capacitor.

However, when an operation target for performing the voltage control is switched as explained above, if a period in which the voltage control is temporarily stopped is prolonged, a phenomenon called “UV (Under Voltage)” in which the voltage of the bulk capacitor falls below a predetermined lower limit threshold sometimes occurs. Even when such UV does not occur, immediately after voltage control using a new operation target is started, a phenomenon called “OV (Over Voltage)” in which the voltage of the bulk capacitor exceeds a predetermined upper limit threshold is likely to occur. If such UV or OV occurs, the control device determines that abnormality has occurred in the power circuit and sometimes stops the charging and power feeding being executed. Therefore, it is preferable to suppress the occurrence of such UV and OV.

An object of the present invention is to provide a power system that can suppress occurrence of UV and OV in switching an operation target for performing voltage control for a bulk capacitor. The present invention contributes to energy efficiency.

(1) A power system (for example, a power system 1 explained below) according to the present invention includes: an electrical storage device (for example, a high-voltage battery B explained below); a voltage converter (for example, a DC-DC converter 3 explained below) connected to the electrical storage device; an inlet (for example, an inlet 4 explained below) to which an external power supply (for example, external AC power supplies EP and EP′ explained below) is connectable; an outlet (for example, an outlet 5 explained below) to which an external load (for example, an external AC load EL explained below) is connectable; a power converter (for example, a power converter 6 explained below) connected to the inlet and the outlet; a bulk capacitor (for example, a bulk capacitor 23 explained below) included in a power line (for example, power lines 21 and 22 explained below) that connects the voltage converter and the power converter; and a control device (for example, a control device 8 explained below) configured to operate the voltage converter and the power converter under any one control mode among a charging mode for charging the electrical storage device with the external power supply, a power feeding mode for feeding power to the external load, and a power feeding during charging mode for feeding power to the external load while charging the electrical storage device, wherein the control device includes: a charging and power feeding request acquirer (for example, a charging/power feeding request acquirer 81 explained below) configured to acquire a charging and power feeding request for charging to the electrical storage device or power feeding to the external load; and a charging and power feeding controller (for example, a charging and power feeding controller 85 explained below) configured to operate the voltage converter to thereby perform voltage control for a bulk voltage, which is a voltage of the bulk capacitor, under the power feeding mode and operate the power converter to thereby perform the voltage control under the charging mode and the power feeding during charging mode, and, when the control mode is switched between the power feeding mode and the power feeding during charging mode according to the charging and power feeding request being acquired, from when the charging and power feeding request is acquired until an operation target of the voltage control is switched between the voltage converter and the power converter, the charging and power feeding controller boosts or steps down the bulk voltage by a predetermined amount from a point in time when the charging and power feeding request is acquired.

(2) In this case, it is preferable that the power converter includes: a first converter circuit (for example, a first converter circuit 71 explained below) including two or more switching legs (for example, a first switching leg 61 and a fourth switching leg 64 explained below) connected to the power line; a second converter circuit (for example, a second converter circuit 72 explained below) including one or more switching legs (for example, a second switching leg 62 and a third switching leg 63 explained below) connected to the power line to be parallel to the first converter circuit; and a switch circuit (for example, a switch circuit 65 explained below) that is switchable between a first connection state in which both of the first and second converter circuits are connected to the inlet and a second connection state in which the first and second converter circuits are respectively connected to the inlet and the outlet, the control device further includes a switch controller (for example, a switch controller 84 explained below) configured to switch the switch circuit to the first connection state under the charging mode and switch the switch circuit to the second connection state under the power feeding mode and the power feeding during charging mode, the charging and power feeding controller performs the voltage control by causing a full PFC circuit configured by the first and second converter circuits to operate as a PFC converter including the inlet on an input side under the charging mode, performs the voltage control by operating the voltage converter under the power feeding mode, and performs the voltage control by causing a half PFC circuit configured by the first converter circuit to operate as the PFC converter under the power feeding during charging mode, and, when the control mode is switched between the charging mode and the power feeding during charging mode according to the charging and power feeding request being acquired, from when the charging and power feeding request is acquired until the operation target is switched between the full PFC circuit and the half PFC circuit, the charging and power feeding controller boosts or steps down the bulk voltage by the predetermined amount from the point in time when the charging and power feeding request is acquired.

(3) In this case, it is preferable that the charging and power feeding controller performs the voltage control by causing the full PFC circuit to operate as the PFC converter and performs charging current control for the electrical storage device by simultaneously operating the voltage converter under the charging mode, performs the voltage control by operating the voltage converter and performs power feeding current control for the external load by simultaneously causing the second converter circuit to operate as an inverter including the bulk capacitor on an input side under the power feeding mode, and performs the voltage control by causing the half PFC circuit to operate as the PFC converter, performs the power feeding current control by causing the second converter circuit to operate as the inverter, and performs the charging current control by simultaneously operating the voltage converter under the power feeding during charging mode.

(4) In this case, it is preferable that, when the control mode is shifted from the charging mode to the power feeding during charging mode, the charging and power feeding controller starts to cause the second converter circuit to operate as the inverter while continuously causing the first converter circuit to operate as the PFC converter.

(5) In this case, it is preferable that, when the control mode is shifted from the power feeding during charging mode to the charging mode, the charging and power feeding controller starts to cause the second converter circuit to operate as the PFC converter while continuously causing the first converter circuit to operate as the PFC converter.

(6) In this case, it is preferable that, when the control mode is shifted from the power feeding mode to the power feeding during charging mode, the charging and power feeding controller starts to cause the first converter circuit to operate as the PFC converter while continuously causing the second converter circuit to operate as the inverter.

(7) In this case, it is preferable that, when the control mode is shifted from the power feeding during charging mode to the power feeding mode, the charging and power feeding controller stops operation of the first converter circuit while continuously causing the second converter circuit to operate as the inverter.

(8) In this case, it is preferable that, when the operation target before the control mode is switched and the operation target after the control mode is switched are respectively defined as an operation target before switching and an operation target after switching, from when the charging and power feeding request is acquired until the operation target is switched from the operation target before switching to the operation target after switching, the charging and power feeding controller operates the operation target before switching to thereby boost or step down the bulk voltage by the predetermined amount from the point in time when the charging and power feeding request is acquired.

(9) In this case, it is preferable that the control device further includes a target value setter (for example, a bulk voltage target value setter 86 explained below) configured to set a bulk voltage target value in the voltage control, the charging and power feeding controller operates the operation target such that the bulk voltage reaches the bulk voltage target value in the voltage control, and, from when the charging and power feeding request is acquired until the operation target is switched from the operation target before switching to the operation target after switching, the target value setter raises or lowers the bulk voltage target value by a predetermined offset value from the point in time when the charging and power feeding request is acquired.

(10) In this case, it is preferable that the control device further includes a power feeding current acquirer (for example, a power feeding current acquirer 87 explained below) configured to acquire a power feeding current to the external load, and, when the control mode is switched between the power feeding mode and the power feeding during charging mode, the target value setter changes the offset value according to the power feeding current.

(1) In the present invention, the charging and power feeding request acquirer acquires the charging and power feeding request for the charging to the electrical storage device and the power feeding to the external load and the charging and power feeding controller performs the voltage control for the bulk voltage by operating the voltage converter under the power feeding mode and performs the voltage control by operating the power converter under the charging mode and the power feeding during charging mode. When the control mode is switched between the power feeding mode and the power feeding during charging mode according to the charging and power feeding request being acquired, from when the charging and power feeding request is acquired until the operation target of the voltage control is switched between the voltage converter and the power converter, the charging and power feeding controller boots or steps down the bulk voltage by the predetermined amount from the point in time when the charging and power feeding request is acquired. According to the present invention, the charging and power feeding controller can suppress occurrence of UV by boosting the bulk voltage by the predetermined amount from the point in time when the charging and power feeding request is acquired. The charging and power feeding controller can suppress occurrence of OV by stepping down the bulk voltage by the predetermined amount from the point in time when the charging and power feeding request is acquired. Thus, according to the present invention, by suppressing occurrence of UV and OV at the switching time of the control mode, it is possible to prevent charging and power feeding being executed from being forcibly stopped. Therefore, as a result, it is possible to contribute to energy efficiency.

(2) In the present invention, the switch controller switches the switch circuit to the first connection state and connects the first and second converter circuits of the power converter to the inlet under the charging mode and switches the switch circuit to the second connection state and connects the first converter circuit to the inlet and connects the second converter circuit to the outlet under the power feeding mode and the power feeding during charging mode. The charging and power feeding controller performs the voltage control by causing the full PFC circuit configured by the first and second converter circuits to operate as the PFC converter under the charging mode, performs the voltage control by operating the voltage converter under the power feeding mode, and performs the voltage control by causing the half PFC circuit configured by the first converter circuit to operate as the PFC converter. When the control mode is switched between the charging mode and the power feeding during charging mode, from when the charging and power feeding request is acquired until the operation target of the voltage control is switched between the full PFC circuit and the half PFC circuit, the charging and power feeding controller can suppress occurrence of UV and OV at the switching time of the control mode by boosting or stepping down the bulk voltage by the predetermined amount from the point in time when the charging and power feeding request is acquired.

(3) According to the present invention, the charging and power feeding controller performs the voltage control by causing the full PFC circuit to operate as the PFC converter and performs the charging current control by simultaneously operating the voltage converter under the charging mode and performs the voltage control by operating the voltage converter and performs the power feeding current control by simultaneously causing the second converter circuit to operate as the inverter under the power feeding mode. The charging and power feeding controller performs the voltage control by causing the half PFC circuit to operate as the PFC converter, performs the power feeding current control by causing the second converter circuit to operate as the inverter, and performs the charging current control by simultaneously operating the voltage converter under the power feeding during charging mode. According to the present invention, it is possible to perform charging, power feeding, and power feeding during charging using a common power converter. Therefore, compared with when charging and power feeding are respectively performed using separate units, it is possible to reduce cost and contribute to energy efficiency.

(4) In the present invention, when the control mode is shifted from the charging mode to the power feeding during charging mode, while continuously causing only the first converter circuit in the full PFC circuit to operate as the PFC converter, the charging and power feeding controller starts to cause the second converter circuit, which has been caused to operate as the PFC converter, to operate as the inverter. Accordingly, when the control mode is shifted from the charging mode to the power feeding during charging mode, it is possible to continue the charging to the electrical storage device and start the power feeding to the external load while suppressing occurrence of UV, OV, and the like as explained above.

(5) In the present invention, when the control mode is shifted from the power feeding during charging mode to the charging mode, while continuously causing the first converter circuit to operate as the PFC converter, the charging and power feeding controller starts to cause the second converter circuit, which has been operating as the inverter, to operate as the PFC converter. Accordingly, when the control mode is shifted from the power feeding during charging mode to the charging mode, it is possible to continue the charging to the electrical storage device and stops the power feeding to the external load while suppressing occurrence of UV and OV as explained above.

(6) In the present invention, when the control mode is shifted from the power feeding mode to the power feeding during charging mode, while continuously causing the second converter circuit to operate as the inverter, the charging and power feeding controller starts to cause the first converter circuit to operate as the PFC converter. Accordingly, when the control mode is shifted from the power feeding mode to the power feeding during charging mode, it is possible to continue the power feeding to the external load and start charging to the electrical storage device while suppressing occurrence of UV and OV as explained above.

(7) In the present invention, when the control mode is shifted from the power feeding during charging mode to the power feeding mode, while continuously causing the second converter circuit to operate as the inverter, the charging and power feeding controller stops operation of the first converter circuit, which has been caused to operate as the PFC converter. Accordingly, when the control mode is shifted from the power feeding during charging mode to the power feeding mode, it is possible to continue the power feeding to the external load and stop the charging to the electrical storage device while suppressing occurrence of UV and OV as explained above.

(8) In the present invention, from when the charging and power feeding request is acquired until the operation target of the voltage control is switched from the operation target before switching to the operation target after switching, the charging and power feeding controller operates the operation target before switching to thereby boost the bulk voltage by the predetermined amount from the point in time when the charging and power feeding request is acquired. Accordingly, at the switching time of the control mode, the bulk voltage at the time when the voltage control using the operation target before switching is stopped can be moved away from the lower limit threshold. Therefore, it is possible to suppress occurrence of UV from when the voltage control using the operation target before switching is stopped until the voltage control using the operation target after switching is started. From when the charging and power feeding request is acquired until the operation target of the voltage control is switched from the operation target before switching to the operation target after switching, the charging and power feeding controller operates the operation target before switching to thereby step down the bulk voltage by the predetermined amount from the point in time when the charging and power feeding request is acquired. Accordingly, at the switching time of the control mode, the bulk voltage at the time when the voltage control using the operation target after switching is started can be moved away from the upper limit threshold. Therefore, it is possible to suppress occurrence of OV immediately after the voltage control using the operation target after switching is started.

(9) In the present invention, the charging and power feeding controller operates, in the voltage control, the operation target such that the bulk voltage reaches the bulk voltage target value set by the target value setter. From when the charging and power feeding request is acquired until the operation target is switched from the operation target before switching to the operation target after switching, the target value setter raises or lowers the bulk voltage target value by the predetermined offset value from the point in time when the charging and power feeding request is acquired. Accordingly, it is possible to suppress occurrence of UV and OV at the switching time of the control mode.

(10) When the control mode is switched between the power feeding mode and the charging and power feeding mode, that is, when the power feeding to the external load is continued before and after the switching of the control mode, a change amount of the bulk voltage during a period in which the voltage control is temporarily stopped differs depending on the magnitude of the power feeding current. Therefore, in the present invention, when the control mode is switched between the power feeding mode and the power feeding during charging mode, the target value setter changes the offset value according to the power feeding current to the external load. Accordingly, it is possible to set the offset value to appropriate magnitude taking into account a change in the bulk voltage while the voltage control is temporarily stopped. Therefore, it is possible to more surely suppress occurrence of UV and OV when the control mode is switched between the power feeding mode and the charging and power feeding mode.

### BRIEF DESCRIPTION OF THE DRAWINGS

FIG. 1 is a diagram illustrating a configuration of a motor-driven vehicle equipped with a power system according to an embodiment of the present invention;

FIG. 2 is a diagram illustrating a configuration of the power system to which an external AC power supply of a three-phase four-line type is connected;

FIG. 3 is a functional block diagram of a control device;

FIG. 4A is a diagram schematically illustrating a flow of electric power in a charging mode;

FIG. 4B is a diagram schematically illustrating a flow of electric power in a power feeding mode;

FIG. 4C is a diagram schematically illustrating a flow of electric power in a power feeding during charging mode;

FIG. 5A is a flowchart illustrating a procedure of control mode determination processing (No. 1);

FIG. 5B is a flowchart illustrating the procedure of the control mode determination processing (No. 2);

FIG. 6A is a time chart illustrating an example of a control procedure for a power converter and a DC-DC converter in a transition period at the time when a control mode is shifted from the charging mode to the power feeding during charging mode;

FIG. 6B is a time chart illustrating an example of a control procedure for the power converter and the DC-DC converter in a transition period at the time when the control mode is shifted from the power feeding during charging mode to the charging mode;

FIG. 6C is a time chart illustrating an example of a control procedure for the power converter and the DC-DC converter in a transition period at the time when the control mode is shifted from the power feeding mode to the power feeding during charging mode;

FIG. 6D is a time chart illustrating an example of a control procedure for the power converter and the DC-DC converter in a transition period at the time when the control mode is shifted from the power feeding during charging mode to the power feeding mode;

FIG. 7 is a diagram illustrating an example of a fluctuation pattern determination table;

FIG. 8 is a time chart illustrating a control example in the case in which there is concern about occurrence of UV when the control mode is shifted from the power feeding mode to the power feeding during charging mode; and

FIG. 9 is a time chart illustrating a control example in the case in which there is concern about occurrence of OV when the control mode is shifted from the power feeding mode to the power feeding during charging mode.

### DETAILED DESCRIPTION OF THE INVENTION

A power system according to an embodiment of the present invention is explained below with reference to the drawings.

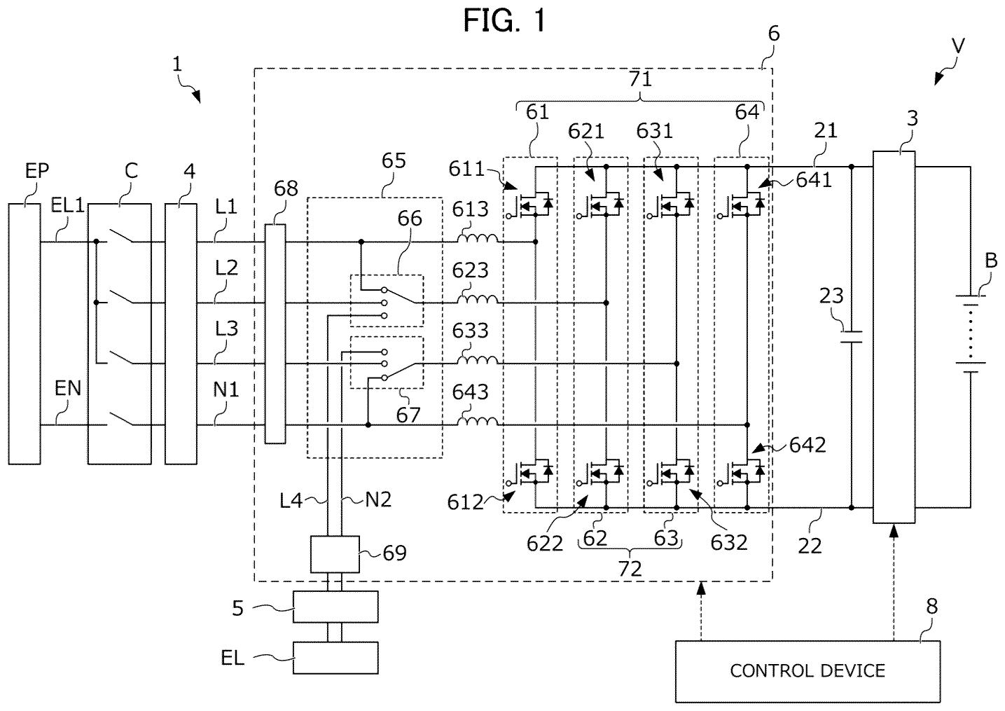

FIG. 1 is a diagram illustrating configurations of a power system 1 according to the present embodiment and a motor-driven vehicle V (hereinafter simply referred to as “vehicle”) equipped with the power system 1. Note that, in the present embodiment, as the vehicle V, an electric automobile that travels by supplying electric power stored in a high-voltage battery B explained below to a driving motor (not illustrated) and rotating driving wheels (not illustrated) is explained as an example. However, the present invention is not limited to this. The power system according to the present invention is applicable to not only the electric automobile but also any vehicle if the vehicle is a motor-driven vehicle that travels using electric power stored in the high-voltage battery B such as a hybrid vehicle or a fuel cell automobile. The power system according to the present invention may be mounted on not only a motor-driven vehicle explained above but also a mobile body such as an electric motorcycle or a motor-driven vertical take-off and landing aircraft (eVTOL).

The power system 1 includes the high-voltage battery B serving as an electrical storage device, a DC-DC converter 3 connected to the high-voltage battery B, an inlet 4 to which an external AC power supply EP is connectable, an outlet 5 to which an external AC load EL is connectable, a power converter 6 connected to the inlet 4 and the outlet 5, a pair of power lines 21 and 22 that connects the DC-DC converter 3 and the power converter 6, a bulk capacitor 23 connected between the DC-DC converter 3 and the power converter 6 in the power lines 21 and 22, and a control device 8 that operates the DC-DC converter 3 and the power converter 6.

The inlet 4 is connected to a switch circuit 65 explained below of the power converter 6 via four power lines L1, L2, L3, and N1. The outlet 5 is connected to the switch circuit 65 of the power converter 6 via two power lines L4 and N2.

As illustrated in FIG. 1, when the external AC power supply EP of a single-phase two-line type and the inlet 4 are connected via a charging cable C, a voltage line EL1 and a neutral line EN of the external AC power supply EP are respectively connected to power the lines L1 and N1 extending from the inlet 4. Accordingly, it is possible to supply single-phase AC power from the external AC power supply EP to the power converter 6 via the power lines L1 and N1. When the external AC load EL of the single-phase two-line type is connected to the outlet 5, the external AC load EL is connected to the power lines L4 and N2 extending from the outlet 5. Accordingly, it is possible to supply single-phase AC power from the power converter 6 to the external AC load EL via the power lines L4 and N2.

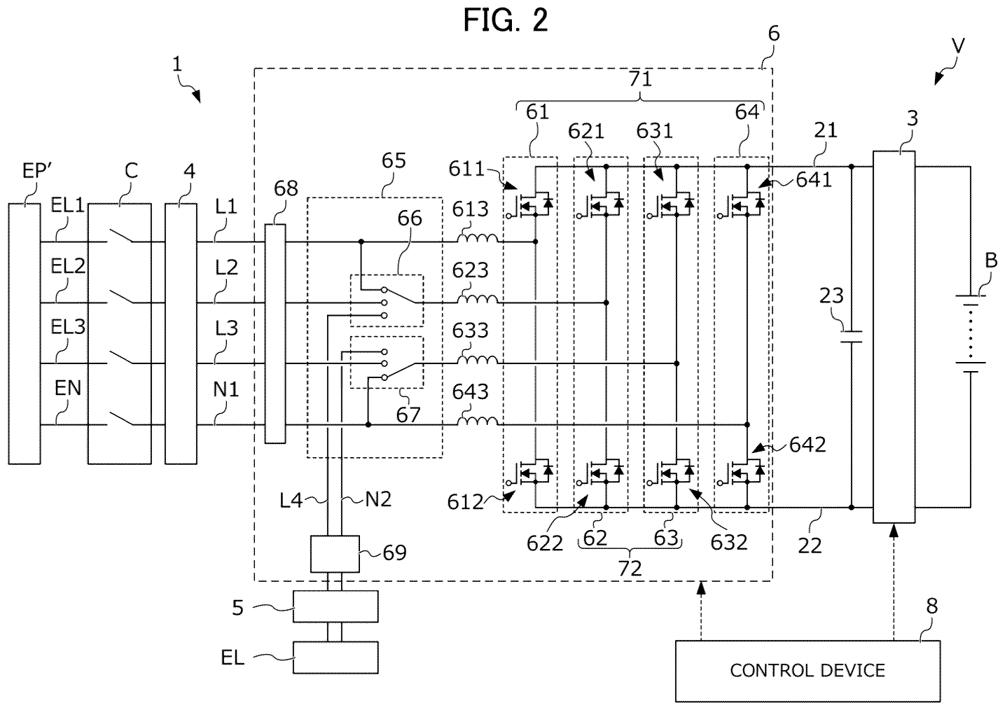

Note that, in the following explanation, a case in which the external AC power supply EP of the single-phase two-line type and the inlet 4 are mainly connected as illustrated in FIG. 1 is explained. However, the present invention is not limited to this. As illustrated in FIG. 2, an external AC power supply EP′ of a three-phase four-line type and the inlet 4 can also be connected via the charging cable C. In this case, three voltage lines EL1, EL2, and EL3 and the neutral line EN of the external AC power supply EP′ are respectively connected to the power lines L1, L2, L3, and N1 extending from the inlet 4. Accordingly, it is possible to supply three-phase AC power from the external AC power supply EP′ to the power converter 6 via the power lines L1, L2, L3, and N1. Even when the external AC power supply EP′ of the three-phase four-line type and the inlet 4 are connected, by using only two power lines L1 and N1, it is possible to supply single-phase AC power from the external AC power supply EP′ to the power converter 6.

Referring back to FIG. 1, the high-voltage battery B is a secondary battery capable of performing both of discharging for converting chemical energy into electric energy and charging for converting electric energy into chemical energy. In the following explanation, a case in which a so-called lithium ion storage battery that performs charging and discharging when lithium ions move between electrodes is used as the high-voltage battery B is explained. However, the present invention is not limited to this.

One end of the DC-DC converter 3 is connected to the bulk capacitor 23 and the other end of the DC-DC converter 3 is connected to the high-voltage battery B. The DC-DC converter 3 boosts and steps down DC power between the bulk capacitor 23 and the high-voltage battery B. The DC-DC converter 3 turns on and off a not-illustrated switching element according to a gate driving signal transmitted from the control device 8 to thereby boost and step down DC power in the bulk capacitor 23 and output the DC power to the high-voltage battery B or boost and step down DC power in the high-voltage battery B and output the DC power to the bulk capacitor 23.

The power converter 6 includes four switching legs 61, 62, 63, and 64, both ends of which are respectively connected to the power lines 21 and 22 to be parallel to the bulk capacitor 23, a switch circuit 65 that connects the switching legs 61 to 64 and the inlet 4 and the outlet 5, a first EMI filter 68 that removes noise in the power lines L1, L2, L3, and N1 that connect the inlet 4 and the switch circuit 65, and a second EMI filter 69 that removes noise in the power lines L4 and N2 that connect the outlet 5 and the switch circuit 65.

A first switching leg 61 includes a first upper arm switching element 611, a first lower arm switching element 612, and a first choke coil 613.

The switching elements 611 and 612 include known power switching elements such as MOSFETs or IGBTs turned on and off according to a gate driving signal transmitted from the control device 8 and diodes connected in parallel to the power switching elements. The first upper arm switching element 611 and the first lower arm switching element 612 are connected in series. A drain of the first upper arm switching element 611 is connected to a positive electrode side power line 21. A source of the first upper arm switching element 611 is connected to a drain of the first lower arm switching element 612. A source of the first lower arm switching element 612 is connected to a negative electrode side power line 22. One end of the first choke coil 613 is connected to a connection point of the first upper arm switching element 611 and the first lower arm switching element 612 and the other end of the first choke coil 613 is connected to the switch circuit 65.

A second switching leg 62 includes a second upper arm switching element 621, a second lower arm switching element 622, and a second choke coil 623.

The switching elements 621 and 622 include known power switching elements such as MOSFETs or IGBTs turned on and off according to a gate driving signal transmitted from the control device 8 and diodes connected in parallel to the power switching elements. The second upper arm switching element 621 and the second lower arm switching element 622 are connected in series. A drain of the second upper arm switching element 621 is connected to the positive electrode side power line 21. A source of the second upper arm switching element 621 is connected to a drain of the second lower arm switching element 622. A source of the second lower arm switching element 622 is connected to the negative electrode side power line 22. One end of the second choke coil 623 is connected to a connection point of the second upper arm switching element 621 and the second lower arm switching element 622 and the other end of the second choke coil 623 is connected to the switch circuit 65.

A third switching leg 63 includes a third upper arm switching element 631, a third lower arm switching element 632, and a third choke coil 633.

The switching elements 631 and 632 include known power switching elements such as MOSFETs or IGBTs turned on and off according to a gate driving signal transmitted from the control device 8 and diodes connected in parallel to the power switching elements. The third upper arm switching element 631 and the third lower arm switching element 632 are connected in series. A drain of the third upper arm switching element 631 is connected to the positive electrode side power line 21. A source of the third upper arm switching element 631 is connected to a drain of the third lower arm switching element 632. A source of the third lower arm switching element 632 is connected to the negative electrode side power line 22. One end of the third choke coil 633 is connected to a connection point of the third upper arm switching element 631 and the third lower arm switching element 632 and the other end of the third choke coil 633 is connected to the switch circuit 65.

A fourth switching leg 64 includes a fourth upper arm switching element 641, a fourth lower arm switching element 642, and a fourth choke coil 643.

The switching elements 641 and 642 include known power switching elements such as MOSFETs or IGBTs turned on and off according to a gate driving signal transmitted from the control device 8 and diodes connected in parallel to the power switching elements. The fourth upper arm switching element 641 and the fourth lower arm switching element 642 are connected in series. A drain of the fourth upper arm switching element 641 is connected to the positive electrode side power line 21. A source of the fourth upper arm switching element 641 is connected to a drain of the fourth lower arm switching element 642. A source of the fourth lower arm switching element 642 is connected to the negative electrode side power line 22. One end of the fourth choke coil 643 is connected to a connection point of the fourth upper arm switching element 641 and the fourth lower arm switching element 642 and the other end of the fourth choke coil 643 is connected to the switch circuit 65.

Note that, in the following explanation, a circuit obtained by combining the first switching leg 61 and the fourth switching leg 64 connected to the power lines 21 and 22 to be parallel to the bulk capacitor 23 is referred to as first converter circuit 71. A circuit obtained by combining the second switching leg 62 and the third switching leg 63 connected to the power lines 21 and 22 to be parallel to the first converter circuit 71 is referred to as second converter circuit 72. In the following explanation, the first and second converter circuits 71 and 72 operating as a PFC converter under the charging mode explained below are collectively referred to as “full PFC circuit” as well. The first converter circuit 71 operating as the PFC converter under the power feeding during charging mode explained below is referred to as “half PFC circuit” as well, meaning the half of the full PFC circuit described above.

The switch circuit 65 is a circuit connecting the choke coils 613, 623, 633, and 643, which are input and output ends of the four switching legs 61, 62, 63, and 64 and six power lines L1, L2, L3, L4, N1, and N2 in total. The switch circuit 65 includes a first relay 66 and a second relay 67 that operate according to an instruction signal from the control device 8.

As illustrated in FIG. 1, the switch circuit 65 always connects the first choke coil 613 of the first switching leg 61 and the power line L1 connected to the inlet 4 and always connects the fourth choke coil 643 of the fourth switching leg 64 and the power line N1 connected to the inlet 4.

The first relay 66 is capable of switching, according to an instruction signal from the control device 8, the second choke coil 623 of the second switching leg 62 to three states in total, that is, a state in which the second choke coil 623 is connected to the power line L1 extending from the inlet 4, a state in which the second choke coil 623 is connected to the power line L2 extending from the inlet 4, and a state in which the second choke coil 623 is connected to the power line L4 extending from the outlet 5.

The second relay 67 is capable of switching, according to an instruction signal from the control device 8, the third choke coil 633 of the third switching leg 63 to three states in total, that is, a state in which the third choke coil 633 is connected to the power line N1 extending from the inlet 4, a state in which the third choke coil 633 is connected to the power line L3 extending from the inlet 4, and a state in which the third choke coil 633 is connected to the power line N2 extending from the outlet 5.

The switch circuit 65 is capable of implementing nine connection states in total because the switch circuit 65 is configured by combining two three-state type relays 66 and 67 explained above.

Note that, in the following explanation, a state in which the second choke coil 623 of the second switching leg 62 and the power line L1 extending from the inlet 4 are connected by the first relay 66 and the third choke coil 633 of the third switching leg 63 and the power line N1 extending from the inlet 4 are connected by the second relay 67, that is, a state in which both of the first converter circuit 71 and the second converter circuit 72 are connected to the inlet 4 is referred to as a first connection state. More specifically, in the first connection state, the first choke coil 613 of the first switching leg 61 and the second choke coil 623 of the second switching leg 62 are connected to the common power line L1 and the third choke coil 633 of the third switching leg 63 and the fourth choke coil 643 of the fourth switching leg 64 are connected to the common power line N1.

A state in which the second choke coil 623 of the second switching leg 62 and the power line L4 extending from the outlet 5 are connected by the first relay 66 and the third choke coil 633 of the third switching leg 63 and the power line N2 extending from the outlet 5 are connected by the second relay 67, that is, a state in which the first converter circuit 71 and the second converter circuit 72 are respectively connected to the inlet 4 and the outlet 5 is referred to as a second connection state.

A state in which the second choke coil 623 of the second switching leg 62 and the power line L2 extending from the inlet 4 are connected by the first relay 66 and the third choke coil 633 of the third switching leg 63 and the power line L3 extending from the inlet 4 are connected by the second relay 67 is referred to as a third connection state.

As explained above, in the present embodiment, the switch circuit 65 is configured by combining the two relays 66 and 67 capable of switching the three states. However, the present invention is not limited to this. The switch circuit 65 may use not only the three-state type relays 66 and 67 but also a known switching unit such as a two-state type relay or switch if the switching unit is capable of implementing a plurality of connection states like the connection states explained above.

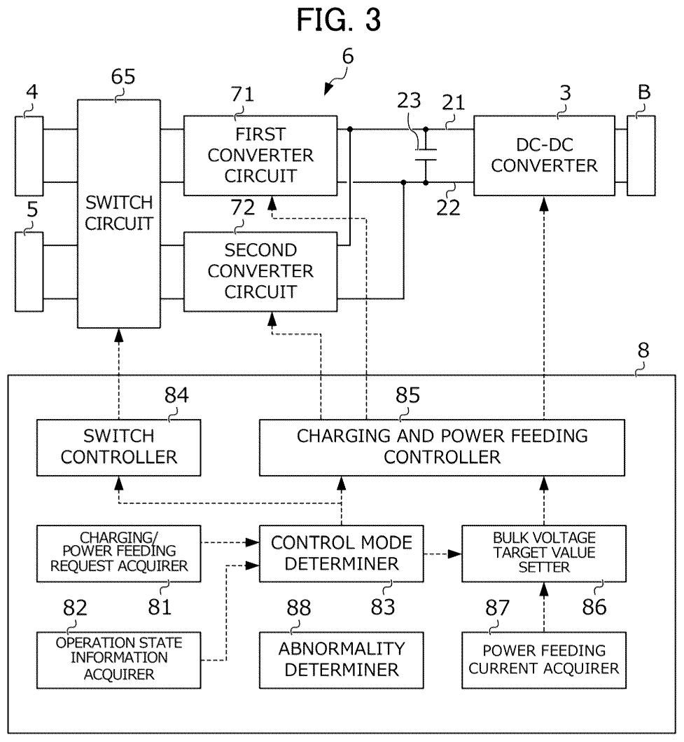

FIG. 3 is a functional block diagram of the control device 8 that operates the DC-DC converter 3 and the power converter 6 explained above.

The control device 8 includes a charging/power feeding request acquirer 81 that acquires a request for charging by the external AC power supply EP or power feeding to the external AC load EL, an operation state information acquirer 82 that acquires operation state information concerning an operation state of the power converter 6 and the DC-DC converter 3, a control mode determiner 83 that determines a control mode for the power converter 6 and the DC-DC converter 3 by the control device 8, a switch controller 84 that operates the switch circuit 65 of the power converter 6 in a mode decided by the determined control mode, a charging and power feeding controller 85 that operates the power converter 6 and the DC-DC converter 3 in a mode decided by the determined control mode, a bulk voltage target value setter 86 that sets a bulk voltage target value in bulk voltage control explained below by the charging and power feeding controller 85, a power feeding current acquirer 87 that acquires a power feeding current supplied to the external AC load EL, and an abnormality determiner 88 that determines presence or absence of abnormality in the power system 1.

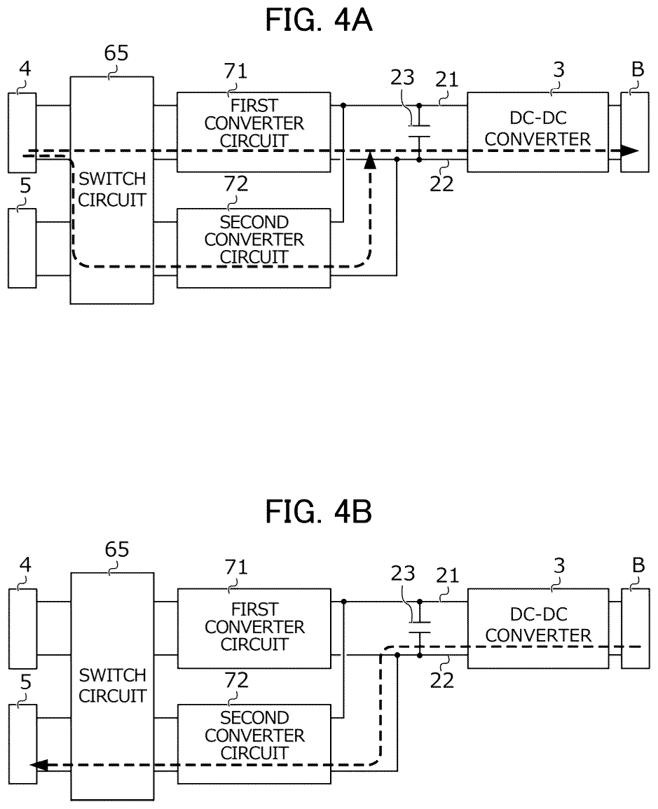

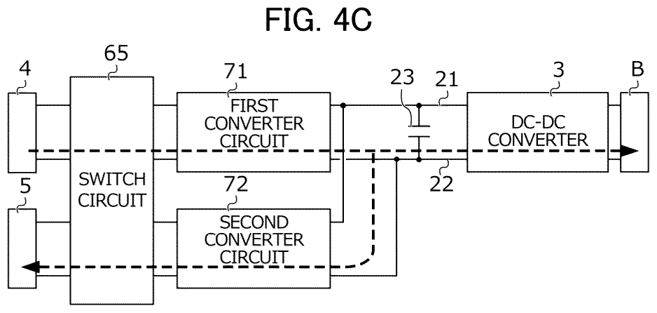

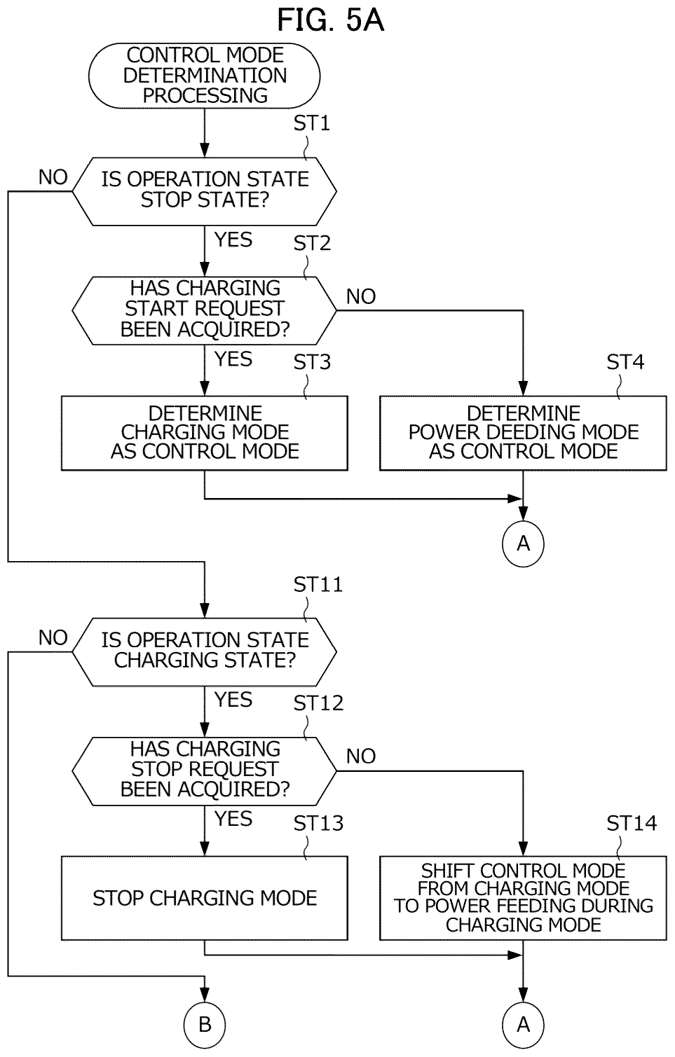

As explained below with reference to FIGS. 4A and 4C, in a state in which the external AC power supply EP and the inlet 4 are connected, the power system 1 is capable of charging a high-voltage battery B with AC power supplied from the external AC power supply EP. As explained below with reference to FIGS. 4B and 4C, in a state in which the external AC load EL is connected to the outlet 5, the power system 1 is capable of feeding power to the external AC load EL using DC power in the bulk capacitor 23.

Therefore, the charging/power feeding request acquirer 81 acquires a request for charging by the external AC power supply EP or power feeding to the external AC load EL. In the following explanation, a request for a start of charging by the external AC power supply EP is referred to as a request for starting charging and a request for a stop of charging by the external AC power supply EP is referred to as a request for stopping charging. A request for a start of power feeding to the external AC load EL is referred to as a request for starting power feeding and a request for a stop of power feeding to the external AC load EL is referred to as a request for stopping power feeding. Note that, in the following explanation, the request for starting charging, the request for stopping charging, the request for starting power feeding, and the request for stopping power feeding acquired by the charging/power feeding request acquirer 81 are collectively referred to as “charging and power feeding request” as well.

The charging/power feeding request acquirer 81 acquires the request for starting charging at the opportunity when, for example, the external AC power supply EP and the inlet 4 have been connected via the charging cable C based on operation by the user. After the charging by the external AC power supply EP is started, the charging/power feeding request acquirer 81 acquires the request for stopping charging at the opportunity when, for example, the remaining power of the high-voltage battery B has exceeded a predetermined amount or predetermined charging stop operation by the user has been detected.

The charging/power feeding request acquirer 81 acquires the request for starting power feeding at the opportunity when, for example, the external AC load EL and the outlet 5 have been connected and predetermined power feeding start operation for a power feeding interface (for example, a power feeding interface switch mounted on a vehicle or a smartphone carried by the user) by the user has been detected. The charging/power feeding request acquirer 81 acquires the request for stopping power feeding at the opportunity when, after the power feeding to the external AC load EL was started, for example, predetermined power feeding stop operation for the power feeding interface by the user has been detected.

The control mode determiner 83 determines a control mode for the power converter 6 and the DC-DC converter 3 by the controllers 84 and 85 explained below. As explained below with reference to FIGS. 4A to 4C, the controllers 84 and 85 are capable of operating the power converter 6 and the DC-DC converter 3 under any one control mode among three kinds of control modes including a charging mode (see FIG. 4A), a power feeding mode (see FIG. 4B), and a power feeding during charging mode (see FIG. 4C) in which flows of electric power in the power converter 6 and the DC-DC converter 3 are different.

FIG. 4A is a diagram schematically illustrating, with a broken line arrow, a flow of electric power at the time when the controllers 84 and 85 operate the power converter 6 and the DC-DC converter 3 under the charging mode.

Under the charging mode, the switch controller 84 operates the relays 66 and 67 of the switch circuit 65 and switches the switch circuit 65 to the first connection state. Accordingly, both of the first converter circuit 71 and the second converter circuit 72 are connected to the power lines L1 and N1 of the inlet 4.

In order to implement the flow of the electric power illustrated in FIG. 4A and charge the high-voltage battery B with the electric power supplied from the external AC power supply EP, the charging and power feeding controller 85 simultaneously performs bulk voltage control for controlling a bulk voltage, which is a voltage of the bulk capacitor 23, to a bulk voltage target value explained below and charging current control for controlling a charging current supplied to the high-voltage battery B to a predetermined charging current target value.

More specifically, under the charging mode, the charging and power feeding controller 85 sets the full PFC circuit configured by the first converter circuit 71 and the second converter circuit 72 as an operation target in the bulk voltage control and performs the bulk voltage control by causing the operation target to operate as a PFC converter including the inlet 4 on an input side. More specifically, under the charging mode, the charging and power feeding controller 85 operates the full PFC circuit such that the full PFC circuit operates as a PFC converter including the inlet 4 on an AC input side and including the bulk capacitor 23 on a DC output side. That is, the charging and power feeding controller 85 operates the full PFC circuit such that AC power input from the external AC power supply EP connected to the inlet 4 is converted into DC power in the full PFC circuit and a power factor approaches one. At this time, the charging and power feeding controller 85 causes the full PFC circuit to operate as a PFC converter such that the bulk voltage reaches the bulk voltage target value set by the bulk voltage target value setter 86 explained below.

Under the charging mode, the charging and power feeding controller 85 performs the bulk voltage control by causing the full PFC circuit to operate as the PFC converter as explained above and performs the charging current control for the high-voltage battery B by simultaneously operating the DC-DC converter 3.

Under the charging mode, the controllers 84 and 85 operate the power converter 6 and the DC-DC converter 3 as explained above to thereby charge the high-voltage battery B with AC power supplied from the external AC power supply EP connected to the inlet 4.

FIG. 4B is a diagram schematically illustrating, with a broken line arrow, a flow of electric power at the time when the controllers 84 and 85 operate the power converter 6 and the DC-DC converter 3 under the power feeding mode.

Under the power feeding mode, the switch controller 84 operates the relays 66 and 67 of the switch circuit 65 and switches the switch circuit 65 to the second connection state. Accordingly, the second converter circuit 72 is connected to the power lines L4 and N2 of the outlet 5.

In order to implement the flow of the electric power illustrated in FIG. 4B and feed power to the external AC load EL with the electric power of the high-voltage battery B, the charging and power feeding controller 85 simultaneously performs the bulk voltage control for controlling the bulk voltage to the bulk voltage target value and the power feeding current control for controlling the power feeding current supplied to the external AC load EL to the predetermined power feeding current target value.

More specifically, under the power feeding mode, the charging and power feeding controller 85 sets the DC-DC converter 3 as an operation target in the bulk voltage control and performs the bulk voltage control by operating the operation target such that the DC power in the high-voltage battery B is supplied to the bulk capacitor 23. That is, the charging and power feeding controller 85 operates the DC-DC converter 3 such that the bulk voltage reaches the bulk voltage target value set by the bulk voltage target value setter 86 explained below.

Under the power feeding mode, the charging and power feeding controller 85 performs the bulk voltage control by operating the DC-DC converter 3 as explained above and performs power feeding current control for the external AC load EL by simultaneously causing the second converter circuit 72 to operate as an inverter including the bulk capacitor 23 on an input side.

Under the power feeding mode, the controllers 84 and 85 operate the power converter 6 and the DC-DC converter 3 as explained above to thereby convert the DC power supplied from the high-voltage battery B into AC power and feed power to the external AC load EL connected to the outlet 5.

FIG. 4C is a diagram schematically illustrating, with a broken line arrow, a flow of electric power at the time when the controllers 84 and 85 operate the power converter 6 and the DC-DC converter 3 under the power feeding during charging mode.

Under the power feeding during charging mode, the switch controller 84 operates the relays 66 and 67 of the switch circuit 65 and switches the switch circuit 65 to the second connection state. Accordingly, the first converter circuit 71 is connected to the power lines L1 and N1 of the inlet 4 and the second converter circuit 72 is connected to the power lines L4 and N2 of the outlet 5.

In order to implement the flow of the electric power illustrated in FIG. 4C and feed power to the external AC load EL while charging the high-voltage battery B, the charging and power feeding controller 85 simultaneously performs the bulk voltage control for controlling the bulk voltage to the bulk voltage target value, the power feeding current control for controlling the power feeding current supplied to the external AC load EL to the power feeding current target value, and the charging current control for controlling the charging current supplied to the high-voltage battery B to the charging current target value.

More specifically, under the power feeding during charging mode, the charging and power feeding controller 85 sets the half PFC circuit configured by the first converter circuit 71 as an operation target and performs the bulk voltage control by causing the operation target to operate as the PFC converter including the inlet 4 on the input side. More specifically, under the power feeding during charging mode, the charging and power feeding controller 85 operates the half PFC circuit such that the half PFC circuit operates as the PFC converter including the inlet 4 on the AC input side and including the bulk capacitor 23 on the DC output side. That is, the charging and power feeding controller 85 operates the half PFC circuit such that the AC power input from the external AC power supply EP connected to the inlet 4 is converted into DC power in the half PFC circuit and a power factor approaches one. At this time, the charging and power feeding controller 85 causes the half PFC circuit to operate as a PFC converter such that the bulk voltage reaches the bulk voltage target value set by the bulk voltage target value setter 86 explained below.

Under the power feeding during charging mode, the charging and power feeding controller 85 performs the bulk voltage control by causing the half PFC circuit to operate as the PFC converter, performs the power feeding current control for the external AC load EL by causing the second converter circuit 72 to operate as the inverter as in the power feeding mode, and performs the charging current control by simultaneously operating the DC-DC converter 3 as in the charging mode as explained above.

Under the power feeding during charging mode, the controllers 84 and 85 operate the power converter 6 and the DC-DC converter 3 as explained above to thereby, while charging the high-voltage battery B with the AC power supplied from the external AC power supply EP connected to the inlet 4, convert the DC power in the bulk capacitor 23 into AC power and feed power to the external AC load EL connected to the outlet 5.

Referring back to FIG. 3, the operation state information acquirer 82 acquires, based on information transmitted from the controllers 84 and 85, operation state information indicating a current operation state of the power converter 6 and the DC-DC converter 3. The operation state information acquirer 82 transmits the acquired operation state information to the control mode determiner 83. The control mode determiner 83 can determine, by referring to the operation state information transmitted from the operation state information acquirer 82, whether the operation state of the power converter 6 and the DC-DC converter 3 is a state in which the power converter 6 and the DC-DC converter 3 are operating under the charging mode (hereafter referred to as “charging state”), a state in which the power converter 6 and the DC-DC converter 3 are operating under the power feeding mode (hereinafter referred to as “power feeding state”), a state in which the power converter 6 and the DC-DC converter 3 are operating under the power feeding during charging mode (hereinafter referred to as “power feeding during charging state”), or a stop state.

When a charging and power feeding request for charging or power feeding is acquired by the charging/power feeding request acquirer 81, the control mode determiner 83 determines a control mode by the controllers 84 and 85 based on the operation state information transmitted from the operation state information acquirer 82 and a type of the acquired charging and power feeding request.

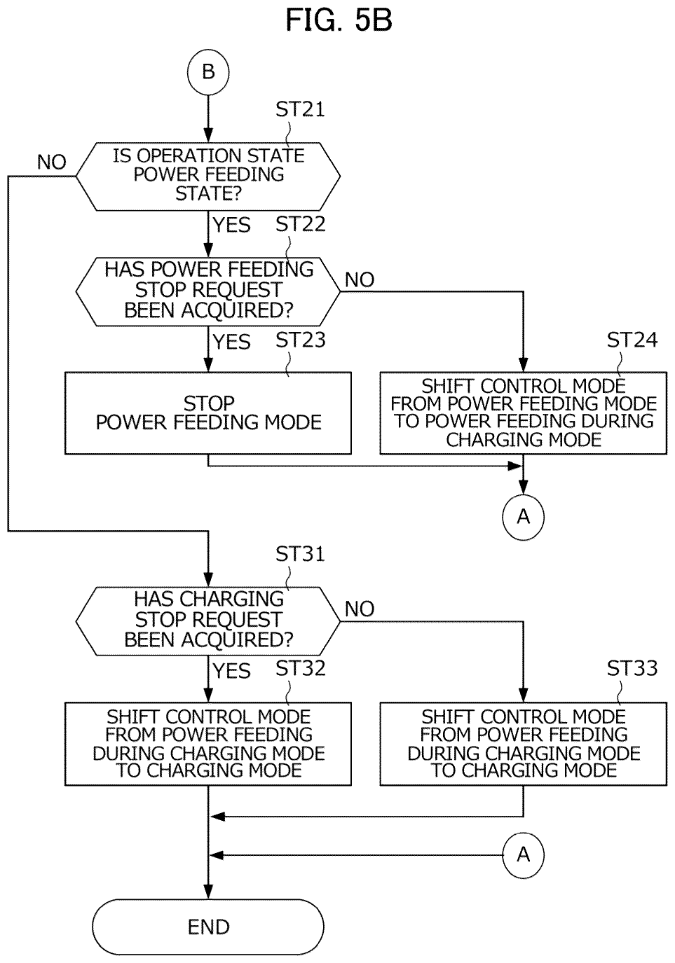

FIGS. 5A and 5B are flowcharts illustrating a specific procedure of the control mode determination processing for determining a control mode in the control mode determiner 83. The control mode determination processing illustrated in FIGS. 5A and 5B is executed by the control mode determiner 83 at the opportunity when some charging and power feeding request has been acquired by the charging/power feeding request acquirer 81.

First, in step ST1, the control mode determiner 83 determines, by referring to the operation state information, whether the current operation state is the stop state. When a determination result in step ST1 is YES, the control mode determiner 83 shifts to step ST2. When the determination result is NO, the control mode determiner 83 shifts to step ST11.

In step ST2, the control mode determiner 83 determines whether the request for starting charging has been acquired. When a determination result in step ST2 is YES, that is, when the request for starting charging has been acquired, the control mode determiner 83 shifts to step ST3. When the determination result in step ST2 is NO, that is, when a request for starting power feeding has been acquired, the control mode determiner 83 shifts to step ST4.

In step ST3, after determining the charging mode as the control mode, the control mode determiner 83 ends the control mode determination processing. Accordingly, the controllers 84 and 85 start operating the power converter 6 and the DC-DC converter 3 according to the procedure explained with reference to FIG. 4A. Accordingly, the operation state of the power converter 6 and the DC-DC converter 3 shifts from the stop state to the charging state.

In step ST4, after determining the power feeding mode as the control mode, the control mode determiner 83 ends the control mode determination processing. Accordingly, the controllers 84 and 85 start operating the power converter 6 and the DC-DC converter 3 according to the procedure explained with reference to FIG. 4B. Accordingly, the operation state of the power converter 6 and the DC-DC converter 3 shifts from the stop state to the power feeding state.

In step ST11, the control mode determiner 83 determines, by referring to the operation state information, whether the current operation state is the charging state. When a determination result in step ST11 is YES, the control mode determiner 83 shifts to step ST12. When the determination result is NO, the control mode determiner 83 shifts to step ST21.

In step ST12, the control mode determiner 83 determines whether the request for stopping charging has been acquired. When a determination result in step ST12 is YES, that is, when the request for stopping charging has been acquired, the control mode determiner 83 shifts to step ST13. When the determination result in step ST12 is NO, that is, when the request for starting power feeding has been acquired, the control mode determiner 83 shifts to step ST14.

In step ST13, after stopping the charging mode, the control mode determiner 83 ends the control mode determination processing. Accordingly, the controllers 84 and 85 stop operating the power converter 6 and the DC-DC converter 3. Accordingly, the operation state of the power converter 6 and the DC-DC converter 3 shifts from the charging state to the stop state.

In step ST14, after shifting the control mode from the charging mode to the power feeding during charging mode, the control mode determiner 83 ends the control mode determination processing. Accordingly, the controllers 84 and 85 start operating the power converter 6 and the DC-DC converter 3 according to the procedure explained with reference to FIG. 4C. Accordingly, the operation state of the power converter 6 and the DC-DC converter 3 shifts from the charging state to the power feeding during charging state.

In step ST21, the control mode determiner 83 determines, by referring to the operation state information, whether the current operation state is the power feeding state. When a determination result in step ST21 is YES, the control mode determiner 83 shifts to step ST22. When the determination result in step ST21 is NO, that is, when the current operation state is the power feeding during charging state, the control mode determiner 83 shifts to step ST31.

In step ST22, the control mode determiner 83 determines whether the request for stopping power feeding has been acquired. When a determination result in step ST22 is YES, that is, when the request for stopping power feeding has been acquired, the control mode determiner 83 shifts to step ST23. When the determination result in step ST22 is NO, that is, when the request for starting charging has been acquired, the control mode determiner 83 shifts to step ST24.

In step ST23, after stopping the power feeding mode, the control mode determiner 83 ends the control mode determination processing. Accordingly, the controllers 84 and 85 stop operating the power converter 6 and the DC-DC converter 3. Accordingly, the operation state of the power converter 6 and the DC-DC converter 3 shifts from the power feeding state to the stop state.

In step ST24, after shifting the control mode from the power feeding mode to the power feeding during charging mode, the control mode determiner 83 ends the control mode determination processing. Accordingly, the controllers 84 and 85 start operating the power converter 6 and the DC-DC converter 3 according to the procedure explained with reference to FIG. 4C. Accordingly, the operation state of the power converter 6 and the DC-DC converter 3 shifts from the power feeding state to the power feeding during charging state.

In step ST31, the control mode determiner 83 determines whether the request for stopping charging has been acquired. When a determination result in step ST31 is YES, that is, when the request for stopping charging has been acquired, the control mode determiner 83 shifts to step ST32. When the determination result in step ST31 is NO, that is, when the request for stopping power feeding has been acquired, the control mode determiner 83 shifts to step ST33.

In step ST32, after shifting the control mode from the power feeding during charging mode to the power feeding mode, the control mode determiner 83 ends the control mode determination processing. Accordingly, the controllers 84 and 85 start operating the power converter 6 and the DC-DC converter 3 according to the procedure explained with reference to FIG. 4B. Accordingly, the operation state of the power converter 6 and the DC-DC converter 3 shifts from the power feeding during charging state to the power feeding state.

In step ST33, after shifting the control mode from the power feeding during charging mode to the charging mode, the control mode determiner 83 ends the control mode determination processing. Accordingly, the controllers 84 and 85 start operating the power converter 6 and the DC-DC converter 3 according to the procedure explained with reference to FIG. 4A. Accordingly, the operation state of the power converter 6 and the DC-DC converter 3 shifts from the power feeding during charging state to the charging state.

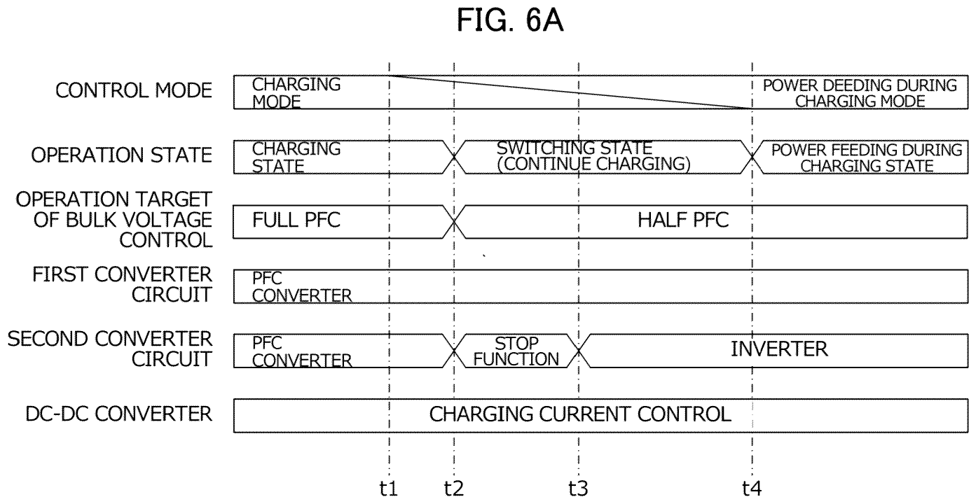

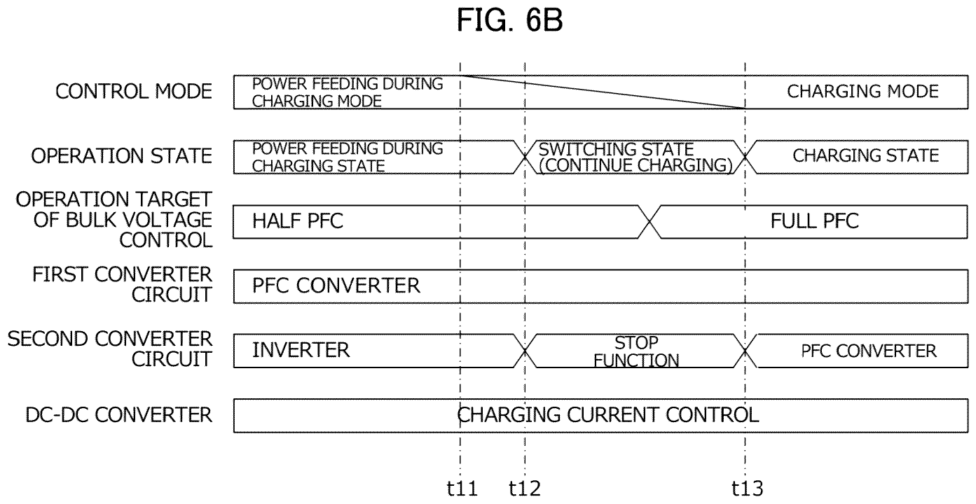

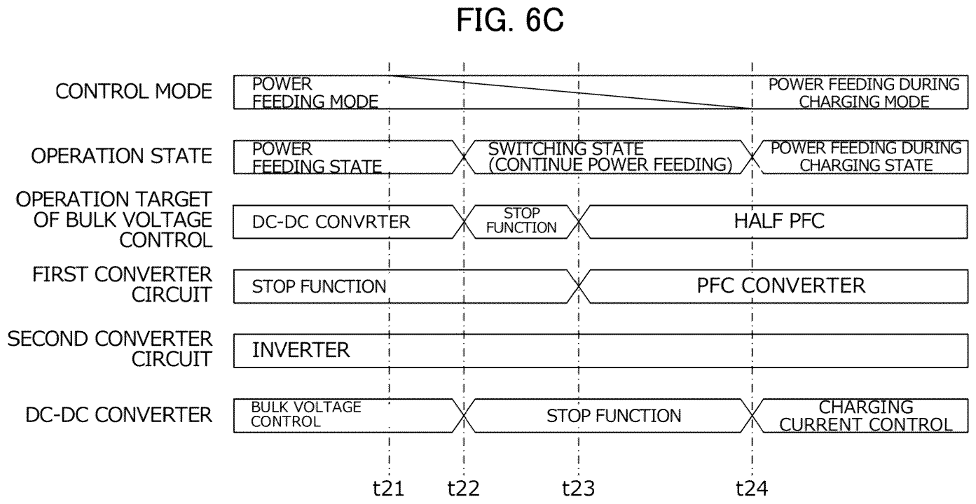

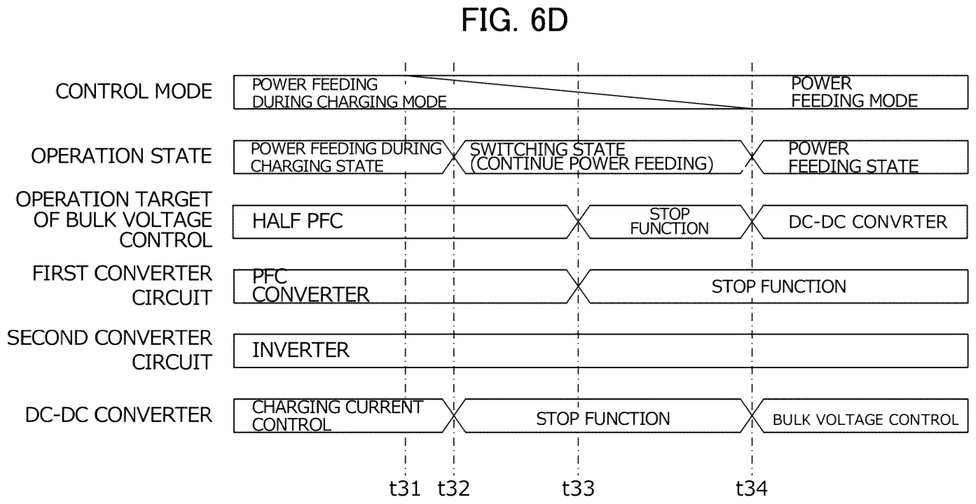

Subsequently, an example of a control procedure for the power converter 6 and the DC-DC converter 3 by the control device 8 in a transition period at the time when the control mode is shifted is explained with reference to time charts illustrated in FIGS. 6A to 6D.

FIG. 6A is a time chart illustrating an example of a control procedure for the power converter 6 and the DC-DC converter 3 in a transition period at the time when the control mode is shifted from the charging mode to the power feeding during charging mode (see step ST14 in FIG. 5A). FIG. 6A illustrates a case in which the request for starting power feeding is acquired at time t1 during a period in which the high-voltage battery B is being charged under the charging mode.

In the example illustrated in FIG. 6A, the control mode determiner 83 starts to shift the control mode from the charging mode to the power feeding charging mode according to the request for starting power feeding being acquired at time t1. The control mode is the charging mode at a point in time when the request for starting power feeding is acquired at time t1. For this reason, at time t1, the charging and power feeding controller 85 performs the bulk voltage control with the full PFC circuit configured by the first converter circuit 71 and the second converter circuit 72 set as an operation target and, at the same time, performs the charging current control by operating the DC-DC converter 3.

Thereafter, at time t2, while continuously causing only the first converter circuit 71 in the full PFC circuit to operate as the PFC converter, the charging and power feeding controller 85 stops the function of the second converter circuit 72, which has been caused to operate as the PFC converter. In other words, the charging and power feeding controller 85 switches the operation target of the bulk voltage control from the full PFC circuit to the half PFC circuit at time t2.

Thereafter, at time t3, while continuously causing the half PFC circuit to operate as the PFC converter, the charging and power feeding controller 85 starts to cause the second converter circuit 72 to operate as the inverter. Thereafter, at time t4, stable AC power starts to be supplied from the second converter circuit 72 operating as the inverter to the external AC load EL connected to the outlet 5. Accordingly, at time t4, the shift from the charging mode to the power feeding during charging mode is completed.

As explained above, when acquiring the request for starting power feeding during a period in which the high-voltage battery B is being charged under the charging mode, the control device 8 shifts the control mode from the charging mode to the power feeding during charging mode by starting to cause the second converter circuit 72 to operate as the inverter while continuously causing the first converter circuit 71 to operate as the PFC converter. Accordingly, at time t1 to t4, even while the operation state of the second converter circuit 72 is switched, it is possible to continue the charging to the high-voltage battery B.

FIG. 6B is a time chart illustrating a procedure of detailed control for the power converter 6 and the DC-DC converter 3 in a transition period at the time when the control mode is shifted from the power feeding during charging mode to the charging mode (see step ST33 in FIG. 5B). FIG. 6B illustrates a case in which, under the power feeding during charging mode, the request for stopping power feeding is acquired at time t11 during a period in which power is being fed to the external AC load EL while the high-voltage battery B is being charged.

In the example illustrated in FIG. 6B, the control mode determiner 83 shifts the control mode from the power feeding during charging mode to the charging mode according the request for stopping power feeding being acquired at time t11. The control mode is the power feeding during charging mode at a point in time when the request for stopping power feeding is acquired at time t11. For this reason, at time t11, the charging and power feeding controller 85 performs the bulk voltage control with the half PFC circuit configured by only the first converter circuit 71 set as an operation target and, at the same time, performs the charging current control by operating the DC-DC converter 3. At the same time, the charging and power feeding controller 85 causes the second converter circuit 72 to operate as the inverter to thereby perform the power feeding current control for the external AC load EL.

Thereafter, at time t12, while continuously causing the half PFC circuit to operate as the PFC converter, the charging and power feeding controller 85 stops the function of the second converter circuit 72, which has been caused to operate as the inverter. Accordingly, at time t12 and subsequent time, the power feeding to the external AC load EL stops.

Thereafter, at time t13, while continuously causing the first converter circuit 71 to operate as the PFC converter, the charging and power feeding controller 85 starts to cause the second converter circuit 72 to operate as the PFC converter. In other words, at time t13, the charging and power feeding controller 85 switches the operation target of the bulk voltage control from the half PFC circuit to the full PFC circuit. Accordingly, at time t13, the shift from the power feeding during charging mode to the charging mode is completed.

As explained above, when the request for stopping power feeding is acquired during a period in which power is being fed to the external AC load EL while the high-voltage battery B is being charged under the power feeding during charging mode, the control device 8 shifts the control mode from the power feeding during charging mode to the charging mode by starting to cause the second converter circuit 72 to operate as the PFC converter while continuously causing the first converter circuit 71 to operate as the PFC converter. Accordingly, at time t11 to t13, even while the operation state of the second converter circuit 72 is switched, the charging to the high-voltage battery B can be continued.

FIG. 6C is a time chart illustrating an example of a control procedure for the power converter 6 and the DC-DC converter 3 in a transition period at the time when the control mode is shifted from the power feeding mode to the power feeding mode during charging mode (see step ST24 in FIG. 5B). FIG. 6C illustrates a case in which the request for starting charging is acquired at time t21 during a period in which power is being fed to the external AC load EL under the power feeding mode.

In the example illustrated in FIG. 6C, the control mode determiner 83 starts to shift the control mode from the power feeding mode to the power feeding during charging mode according to the request for starting charging being acquired at time t21. The control mode is the power feeding mode at a point in time when the request for starting charging is acquired at time t21. Accordingly, at time t21, the charging and power feeding controller 85 performs the bulk voltage control with the DC-DC converter 3 set as an operation target and, at the same time, performs the power feeding current control for the external AC load EL by causing the second converter circuit 72 to operate as the inverter.

Thereafter, at time t22, while continuously causing the second converter circuit 72 to operate as the inverter, the charging and power feeding controller 85 stops the operation of the DC-DC converter 3. That is, at time t22, the charging and power feeding controller 85 stops the bulk voltage control with the DC-DC converter 3 set as the operation target. When the bulk voltage control is stopped as explained above, although the bulk voltage starts to drop at time t22 and subsequent time, the charging and power feeding controller 85 performs the power feeding current control by causing the second converter circuit 72 to operate as the inverter. Therefore, it is possible to temporarily continue the power feeding to the external AC load EL.

Thereafter, at time t23, while continuously causing the second converter circuit 72 to operate as the inverter, the charging and power feeding controller 85 starts the bulk voltage control with the half PFC circuit (that is, the first converter circuit 71), which has been stopped, set as an operation target. In other words, the charging and power feeding controller 85 switches the operation target of the bulk voltage control from the DC-DC converter 3 to the half PFC circuit at time t23.

Thereafter, at time t24, the charging and power feeding controller 85 starts the charging current control for the high-voltage battery B by operating the DC-DC converter 3. Accordingly, at time t24, a charging current starts to be supplied to the high-voltage battery B. Accordingly, at time t24, the shift from the power feeding mode to the power feeding during charging mode is completed.

As explained above, when the request for starting charging is acquired during a period in which the power is being fed to the external AC load EL under the power feeding mode, the control device 8 shifts the control mode from the power feeding mode to the power feeding during charging mode by starting to cause the first converter circuit 71 to operate as the PFC converter while continuously causing the second converter circuit 72 to operate as the inverter. Accordingly, at time t21 to t24, even while the operation state of the DC-DC converter 3 and the first converter circuit 71 is switched, it is possible to continue the power feeding to the external AC load EL.

FIG. 6D is a time chart illustrating an example of a control procedure for the power converter 6 and the DC-DC converter 3 in a transition period at the time when the control mode is shifted from the power feeding during charging mode to the charging mode (see step ST32 in FIG. 5B). FIG. 6D illustrates a case in which the request for stopping charging is acquired at time t31 during a period in which power is being fed to the external AC load EL while the high-voltage battery B is being charged.

In the example illustrated in FIG. 6D, the control mode determiner 83 starts to shift the control mode from the power feeding during charging mode to the power feeding mode according to the request for stopping charging being acquired at time t31. The control mode is the power feeding during charging mode at a point in time when the request for stopping charging is acquired at time t31. Accordingly, at time t31, the charging and power feeding controller 85 performs the bulk voltage control with the half PFC circuit configured by only the first converter circuit 71 set as an operation target and, at the same time, performs the charging current control by operating the DC-DC converter 3. At the same time, the charging and power feeding controller 85 causes the second converter circuit 72 to operate as the inverter to thereby perform the power feeding current control for the external AC load EL.

Thereafter, at time t32, while continuously causing the second converter circuit 72 to operate as the inverter, the charging and power feeding controller 85 stops the function of the DC-DC converter 3. Accordingly, the charging to the high-voltage battery B stops.

Thereafter, at time t33, while continuously causing the second converter circuit 72 to operate as the inverter, the charging and power feeding controller 85 stops the function of the first converter circuit 71. That is, at time t33, the charging and power feeding controller 85 stops the bulk voltage control with the half PFC circuit set as the operation target. When the bulk voltage control is stopped as explained above, although the bulk voltage starts to drop at time t33 and subsequent time, the charging and power feeding controller 85 performs the power feeding current control by causing the second converter circuit 72 to operate as the inverter. Therefore, it is possible to temporarily continue the power feeding to the external AC load EL.

Thereafter, at time t34, the charging and power feeding controller 85 starts the bulk voltage control with the DC-DC converter 3 set as an operation target. In other words, at time t34, the charging and power feeding controller 85 switches the operation target of the bulk voltage control from the half PFC circuit to the DC-DC converter 3. Accordingly, at time t34, the shift from the power feeding during charging mode to the power feeding mode is completed.

As explained above, when the request for stopping charging is acquired during a period in which the power is being fed to the external AC load EL while the high-voltage battery B is being charged under the power feeding during charging mode, the control device 8 shifts the control mode from the power feeding during charging mode to the power feeding mode by stopping the operation of the first converter circuit 71 while continuously causing the second converter circuit 72 to operate as the inverter. Accordingly, at time t31 to t34, even while the operation state of the DC-DC converter 3 and the first converter circuit 71 is switched, the power feeding to the external AC load EL can be continued.

Referring back to FIG. 3, during a period in which the power is being fed to the external AC load EL under the power feeding mode and the power feeding during charging mode, the power feeding current acquirer 87 acquires a power feeding current to the external AC load EL using a not-illustrated current sensor.

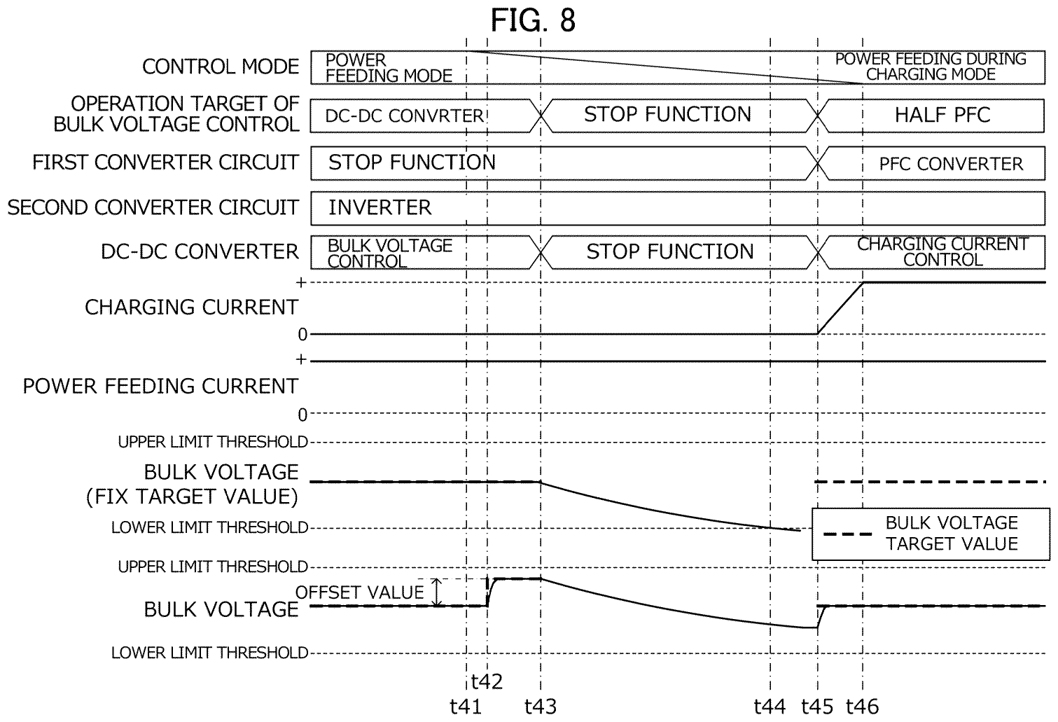

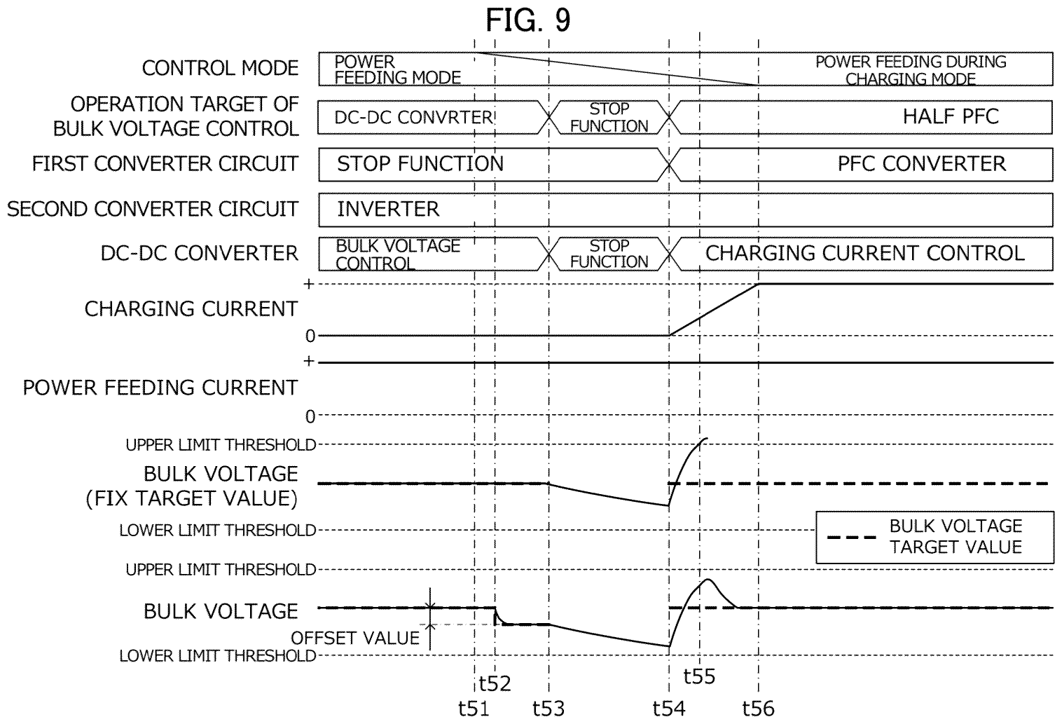

The abnormality determiner 88 detects presence or absence of abnormality in the power system 1 by monitoring a bulk voltage while the charging and the power feeding are performed under the control by the controllers 84 and 85. More specifically, when a bulk voltage acquired using a not-illustrated voltage sensor while the charging and the power feeding are performed has fallen below a predetermined lower limit threshold (see FIGS. 8 and 9 and the like referred to below) (that is, when UV has occurred) or when the bulk voltage has exceeded a predetermined upper limit threshold (see FIGS. 8 and 9 and the like referred to below) (that is, when OV has occurred), the abnormality determiner 88 determines that some abnormality has occurred in the power system 1 and stops the bulk voltage control, the charging current control, the power feeding current control, and the like executed in the charging and power feeding controller 85.

The bulk voltage target value setter 86 sets the bulk voltage target value in the bulk voltage control explained above to magnitude decided for each of the control modes within a range between the lower limit threshold and the upper limit threshold.

Incidentally, when the control mode is switched between the power feeding mode and the power feeding during charging mode (see FIGS. 6C and 6D) and when the control mode is switched between the charging mode and the power feeding during charging mode (see FIGS. 6A and 6B), the charging and power feeding controller 85 needs to switch the operation target of the bulk voltage control. That is, when the control mode is switched between the power feeding mode and the power feeding during charging mode, it is necessary to switch the operation target of the bulk voltage control between the DC-DC converter 3 and the half PFC circuit (that is, the first converter circuit 71). When the control mode is switched between the charging mode and the power feeding during charging mode, it is necessary to switch the operation target of the bulk voltage control between the full PFC circuit (that is, the first converter circuit 71 and the second converter circuit 72) and the half PFC circuit.

Note that, in the present embodiment, the operation target of the bulk voltage control before the control mode is switched and the operation target of the bulk voltage control after the control mode is switched are respectively defined as an operation target before switching and an operation target after switching. That is, when the control mode is shifted from the power feeding mode to the power feeding during charging mode (see FIG. 6C), the operation target before switching is the DC-DC converter 3 and the operation target after switching is the half PFC circuit. When the control mode is shifted from the power feeding during charging mode to the power feeding mode (see FIG. 6D), the operation target before switching is the half PFC circuit and the operation target after switching is the DC-DC converter 3. When the control mode is shifted from the charging mode to the power feeding during charging mode (see FIG. 6A), the operation target before switching is the full PFC circuit and the operation target after switching is the half PFC circuit. When the control mode is shifted from the power feeding during charging mode to the charging mode (see FIG. 6B), the operation target before switching is the half PFC circuit and the operation target after switching is the full PFC circuit.

Since the operation target of the bulk voltage control also needs to be switched at the switching time of the control mode as explained above, at the switching time of the control mode, the bulk voltage control by the charging and power feeding controller 85 sometimes temporarily stops (see time t22 to t23 in FIG. 6C and time t33 to t34 in FIG. 6D). When such a stop period of the bulk voltage control is set long, electric charges of the bulk capacitor 23 are discharged in the stop period, whereby the bulk voltage greatly drops to be lower than the lower limit threshold. It is sometimes determined by the abnormality determiner 88 that abnormality has occurred. That is, when the stop period of the bulk voltage control at the switching time of the control mode is set long, there is concern about occurrence of UV.

When the stop period of the bulk voltage control is set short, UV explained above is less easily occurs. However, immediately after the charging and power feeding controller 85 starts the bulk voltage control by operating the operation target after switching, the bulk voltage sometimes overshoots from the bulk voltage target value. For this reason, immediately after the bulk voltage control is started, the bulk voltage exceeds the upper limit threshold. It is sometimes determined by the abnormality determiner 88 that abnormality has occurred. Note that an overshoot amount of the bulk voltage immediately after the start of the bulk voltage control greatly depends on a circuit configuration of the operation target after switching, setting of the bulk voltage control in the charging and power feeding controller 85, and the like. Because of such reasons, there is sometimes concern about occurrence of OV.

As explained above, at the switching time of the control mode, there is concern about occurrence of UV or OV. Whether the concern involves occurrence of UV or OV mainly depends on the circuit configuration and the setting of the control as explained above. Whether the concern involves occurrence of UV or OV sometimes differs among switching scenes of the control mode. A fluctuation amount of the bulk voltage at the switching time of the control mode also sometimes differs among switching scenes of the control mode.

Therefore, in order to suppress UV or OV at the switching time of the control mode explained above, by raising or lowering the bulk voltage target value from a predetermined reference value at predetermined timing at the switching time of the control mode, the bulk voltage under the control of the bulk voltage control by the charging and power feeding controller 85 is boosted or stepped down by a predetermined amount from a predetermined reference voltage.

More specifically, at the switching time of the control mode (that is, when the control mode is switched between the power feeding mode and the power feeding during charging mode and when the control mode is switched between the charging mode and the power feeding during charging mode), from when the charging and power feeding request is acquired by the charging/power feeding request acquirer 81 until the operation target of the bulk voltage control by the charging and power feeding controller 85 is switched from the operation target before switching to the operation target after switching and while the bulk voltage control using the operation target before switching is performed by the charging and power feeding controller 85, the bulk voltage target value setter 86 sets a value at a point in time when the charging and power feeding request is acquired as a reference value and raises or lowers the bulk voltage target value by a predetermined offset value from the reference value.

When the bulk voltage target value is raised or lowered at such timing, from when the charging and power feeding request is acquired until the operation target of the bulk voltage control is switched from the operation target before switching to the operation target after switching, the charging and power feeding controller 85 sets a voltage at a point in time when the charging and power feeding request is acquired as a reference voltage and boosts or steps down, with the bulk voltage control using the operation target before switching, the bulk voltage by an amount corresponding to the offset value from the reference voltage. Accordingly, it is possible to suppress occurrence of UV or OV at the switching time of the control mode.

That is, when there is concern of occurrence of UV at the switching time of the control mode, the bulk voltage target value setter 86 raises the bulk voltage target value by the offset value from the reference value such that the bulk voltage at the switching time of the control mode moves away from the lower limit threshold. When there is concern of occurrence of OV at the switching time of the control mode, the bulk voltage target value setter 86 lowers the bulk voltage target value by the offset value from the reference value such that the bulk voltage at the switching time of the control mode moves away from the upper limit threshold.

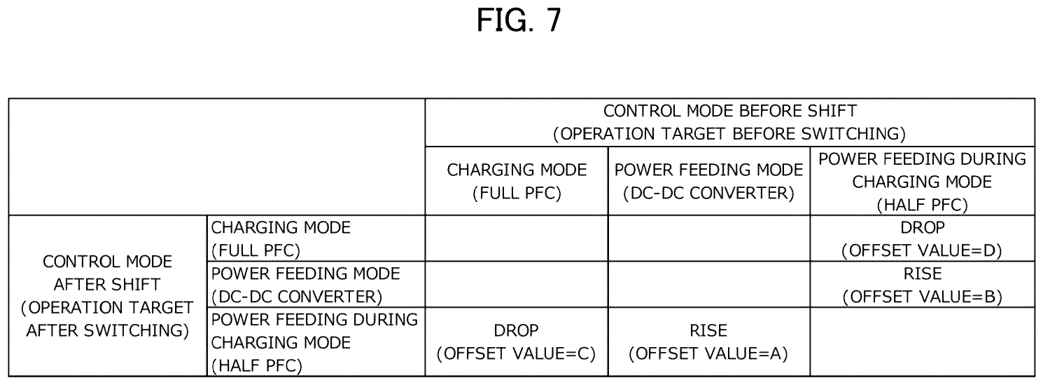

As explained above, whether the concern involves occurrence of UV or OV differs among switching scenes of the control mode. The fluctuation amount of the bulk voltage at the switching time of the control mode also sometimes differs among the switching scenes of the control mode. Therefore, when the charging and power feeding request is acquired, it is preferable that the bulk voltage target value setter 86 determines a specific fluctuation pattern of the bulk voltage target value at the switching time of the control mode by referring to, for example, a table illustrated in FIG. 7.

FIG. 7 is a diagram illustrating an example of a fluctuation pattern determination table for determining a fluctuation pattern of the bulk voltage target value at the switching time of the control mode. As illustrated in FIG. 7, the fluctuation pattern determination table correlates a control mode before shift (or the operation target before switching), a control mode after shift (the operation target after switching) determined by the flowcharts of FIGS. 5A and 5B based on content of the charging and power feeding request, and the fluctuation pattern of the bulk voltage target value.

According to the example of the fluctuation pattern determination table illustrated in FIG. 7, when the control mode shifts from the power feeding mode to the power feeding during charging mode, that is, when the operation target of the bulk voltage control is switched from the DC-DC converter 3 to the half PFC circuit, there is concern of occurrence of UV. Therefore, the bulk voltage target value setter 86 raises the bulk voltage target value by a value A. When the control mode shifts from the power feeding during charging mode to the power feeding mode, that is, when the operation target of the bulk voltage control is switched from the half PFC circuit to the DC-DC converter 3, there is concern of occurrence of UV. Therefore, the bulk voltage target value setter 86 raises the bulk voltage target value by a value B. When the control mode shifts from the charging mode to the power feeding during charging mode, that is, when the operation target of the bulk voltage control is switched from the full PFC circuit to the half PFC circuit, there is concern of occurrence of OV. Therefore, the bulk voltage target value setter 86 lowers the bulk voltage target value by a value C. When the control mode shifts from the power feeding during charging mode to the charging mode, that is, when the operation target of the bulk voltage control is switched from the half PFC circuit to the full PFC circuit, the bulk voltage target value setter 86 lowers the bulk voltage target value by a value D.

Note that the fluctuation pattern determination table illustrated in FIG. 7 is only an example. The present invention is not limited to this. That is, it is preferable that, for each of the shift patterns of the control mode, whether to raise or lower the bulk voltage target value is decided by performing, in advance, design and a test assuming dispersion. Similarly, it is preferable that a detailed value of the offset value is decided by performing, in advance, design and a test assuming dispersion.

Subsequently, specific control examples in the case in which occurrence of UV is suppressed by fluctuating the bulk voltage target value and the case in which occurrence of OV is suppressed by fluctuating the bulk voltage target value are explained with reference to FIGS. 8 and 9.

FIG. 8 is a time chart illustrating a control example in the case in which there is concern of occurrence of UV when the control mode shifts from the power feeding mode to the power feeding during charging mode. FIG. 8 illustrates a case in which the request for starting charging is acquired at time t41 during a period in which the power is being fed to the external AC load EL under the power feeding mode. FIG. 8 illustrates a case in which the charging and power feeding controller 85 ends, according to the request for starting charging being acquired at time t41, at time t43, the bulk voltage control with the DC-DC converter 3 set as the operation target, thereafter, starts, at time t45, the bulk voltage control with the half PFC circuits set as the operation target, and, thereafter, completes the shift to the power feeding during charging mode according to the charging current being stabilized at time t46.

First, a case in which the bulk voltage target value is continuously fixed without being changed from when the request for starting charging is acquired at time t41 until the bulk voltage control using the DC-DC converter 3 serving as the operation target before switching is ended at time t43 is explained. In this case, when the bulk voltage control is stopped at time t43 while the power feeding current is continuously supplied to the external AC load EL, the bulk voltage starts to drop as illustrated in a second part from the bottom of FIG. 8. For this reason, when the period in which the bulk voltage control is stopped is prolonged, it is likely that the bulk voltage falls below the lower limit threshold at time t44, UV occurs before the bulk voltage control is resumed, and the system stops.

In contrast, from when the request for starting charging is acquired until the operation target is switched from the DC-DC converter 3 to the half PFC circuit and while the charging and power feeding controller 85 is performing the bulk voltage control using the DC-DC converter 3 (in the example illustrated in FIG. 8, at time t41 to t43), in order to suppress occurrence of UV explained above, the bulk voltage target value setter 86 sets, as a reference value, a value at time t41 when the charging and request for starting power feeding is acquired and raises the bulk voltage target value by a predetermined offset value. According to the bulk voltage target value being raised, the charging and power feeding controller 85 performs the bulk voltage control using the DC-DC converter 3 to thereby, at time t42 to time t43, set the bulk voltage at time t41 as a reference voltage and boost the bulk voltage by an amount corresponding to the offset value from the reference voltage. For this reason, from when the bulk voltage control is stopped at time t43 while the power feeding current is continuously supplied to the external AC load EL until the bulk voltage control is started at time t45, the bulk voltage does not fall below the lower limit threshold. That is, occurrence of UV can be suppressed.

Incidentally, a drop amount of the bulk voltage during a period in which the bulk voltage control is stopped is larger as the power feeding current to the external AC load EL increases. For this reason, when the control mode is switched between the power feeding mode and the power feeding during charging mode, that is, when the control mode is switched while the power feeding to the external AC load EL is continued, it is preferable that the bulk voltage target value setter 86 changes the offset value according to the magnitude of the power feeding current acquired by the power feeding current acquirer 87. More specifically, since the drop amount of the bulk voltage is larger as the power feeding current is larger, it is preferable that the bulk voltage target value setter 86 changes the offset value to a larger value as the power feeding current is larger.

FIG. 9 is a time chart illustrating a control example in the case in which there is concern of occurrence of OV when the control mode shifts from the power feeding mode to the power feeding during charging mode. FIG. 9 illustrates a case in which the request for starting charging is acquired at time t51 during a period in which the power is being fed to the external AC load EL under the power feeding mode. FIG. 9 illustrates a case in which the charging and power feeding controller 85 ends, according to the request for starting charging being acquired at time t51, at time t53, the bulk voltage control with the DC-DC converter 3 set as the operation target, thereafter, starts, at time t54, the bulk voltage control with the half PFC circuit set as the operation target, and, thereafter, completes the shift to the power feeding during charging mode according to the charging current being stabilized at time t56.

First, a case in which, from when the request for starting charging is acquired at time t51 until the bulk voltage control using the DC-DC converter 3 serving as the operation target before switching is ended at time t53, the bulk voltage target value is continuously fixed without being changed is explained. In this case, after the bulk voltage control using the DC-DC converter 3 is ended at time t53, when the bulk voltage control with the half PFC circuit set as the operation target is resumed at time t54, the bulk voltage sometimes overshoots the bulk voltage target value immediately after the resumption as illustrated in a second part from the bottom of FIG. 9. For this reason, it is likely that, at time t55, the bulk voltage exceeds the upper limit threshold, OV occurs before the bulk voltage control is resumed, and the system stops.

In contrast, from when the request for starting charging is acquired until the operation target is switched from the DC-DC converter 3 to the half PFC circuit and while the charging and power feeding controller 85 is performing the bulk voltage control using the DC-DC converter 3 (in the example illustrated in FIG. 9, time t51 to t53), in order to suppress occurrence of OV explained above, the bulk voltage target value setter 86 sets, as a reference value, a value at time t51 when the charging and request for starting power feeding is acquired and lowers the bulk voltage target value by the predetermined offset value. According to the bulk voltage value being lowered, the charging and power feeding controller 85 performs the bulk voltage control using the DC-DC converter 3 to thereby set, at time t52 to time t53, the bulk voltage at the time t51 as a reference voltage and steps down the bulk voltage by an amount corresponding to the offset value from the reference voltage. For this reason, the bulk voltage at a point in time when the bulk voltage control with the half PFC circuit set as the operation target is started at time t54 can be moved further away from the upper limit threshold than when the bulk voltage target value is fixed. For this reason, immediately after the bulk voltage control is resumed at time t54, even if the bulk voltage overshoots the bulk voltage target value, the bulk voltage does not exceed the upper limit threshold. That is, occurrence of OV can be suppressed.

Note that a specific procedure for suppressing occurrence of UV and OV when the control mode shifts from the power feeding during charging mode to the power feeding mode, when the control mode shifts from the charging mode to the power feeding during charging mode, and when the control mode shifts from the power feeding during charging mode to the charging mode is substantially the same as the procedure explained with reference to FIGS. 8 and 9. Therefore, detailed explanation of the procedure is omitted.

With the power system 1 according to the present embodiment, the following effects are achieved.

(1) The charging/power feeding request acquirer 81 acquires the charging and power feeding request for the charging to the high-voltage battery B or the power feeding to the external AC load EL. The charging and power feeding controller 85 performs the bulk voltage control by operating the DC-DC converter 3 under the power feeding mode and performs the bulk voltage control by operating the power converter 6 under the charging mode and the power feeding during charging mode. When the control mode is switched between the power feeding mode and the power feeding during charging mode according to the charging and power feeding request being acquired, from when the charging and power feeding request is acquired until the operation target of the bulk voltage control is switched between the DC-DC converter 3 and the power converter 6, the charging and power feeding controller 85 boosts or steps down the bulk voltage by the predetermined amount from the point in time when the charging and power feeding request is acquired. With the power system 1, the charging and power feeding controller 85 can suppress occurrence of UV by boosting the bulk voltage by the predetermined amount from the point in time when the charging and power feeding request is acquired. The charging and power feeding controller 85 can suppress occurrence of OV by stepping down the bulk voltage by the predetermined amount from the point in time when the charging and power feeding request is acquired. Thus, with the power system 1, by suppressing occurrence of UV and OV at the switching time of the control mode, it is possible to prevent charging and power feeding being executed from being forcibly stopped. Therefore, as a result, it is possible to contribute to energy efficiency.

(2) The switch controller 84 switches the switch circuit 65 to the first connection state and connects the converter circuits 71 and 72 of the power converter 6 to the inlet 4 under the charging mode and switches the switch circuit 65 to the second connection state and connects the first converter circuit 71 to the inlet 4 and connects the second converter circuit 72 to the outlet 5 under the power feeding mode and the power feeding during charging mode. The charging and power feeding controller 85 performs the bulk voltage control by causing the full PFC circuit configured by the converter circuits 71 and 72 to operate as the PFC converter under the charging mode, performs the bulk voltage control by operating the DC-DC converter 3 under the power feeding mode, and performs the bulk voltage control by causing the half PFC circuit configured by the first converter circuit 71 to operate as the PFC converter under the power feeding during charging mode. When the control mode is switched between the charging mode and the power feeding during charging mode, from when the charging and power feeding request is acquired until the operation target of the bulk voltage control is switched between the full PFC circuit and the half PFC circuit, the charging and power feeding controller 85 can suppress occurrence of UV and OV at the switching time of the control mode by boosting or stepping down the bulk voltage by the predetermined amount from the point in time when the charging and power feeding request is acquired.

(3) The charging and power feeding controller 85 performs the bulk voltage control by causing the full PFC circuit to operate as the PFC converter and performs the charging current control by simultaneously operating the DC-DC converter 3 under the charging mode and performs the bulk voltage control by operating the DC-DC converter 3 and performs the power feeding current control by simultaneously causing the second converter circuit 72 to operate as the inverter under the power feeding mode. The charging and power feeding controller 85 performs the bulk voltage control by causing the half PFC circuit to operate as the PFC converter, performs the power feeding current control by causing the second converter circuit 72 to operate as the inverter, and performs the charging current control by simultaneously operating the DC-DC converter 3 under the power feeding during charging mode. With the power system 1, charging, power feeding, and power feeding during charging can be performed using the common power converter 6. Therefore, it is possible to reduce cost compared with when charging and power feeding are respectively performed using separate units. It is possible to contribute to energy efficiency.

(4) When the control mode is shifted from the charging mode to the power feeding during charging mode, while continuously causing only the first converter circuit 71 in the full PFC circuit to operate as the PFC converter, the charging and power feeding controller 85 starts to cause the second converter circuit 72, which has been caused to operate as the PFC converter, to operate as the inverter. Accordingly, when the control mode is shifted from the charging mode to the power feeding during charging mode, it is possible to continue the charging to the high-voltage battery B and start the power feeding to the external AC load EL while suppressing occurrence of UV, OV, and the like as explained above.

(5) When the control mode is shifted from the power feeding during charging mode to the charging mode, while continuously causing the first converter circuit 71 to operate as the PFC converter, the charging and power feeding controller 85 starts to cause the second converter circuit 72, which has been operating as the inverter, to operate as the PFC converter. Accordingly, when the control mode is shifted from the power feeding during charging mode to the charging mode, it is possible to continue the charging to the high-voltage battery B and stops the power feeding to the external AC load EL while suppressing occurrence of UV and OV as explained above.

(6) When the control mode is shifted from the power feeding mode to the power feeding during charging mode, while continuously causing the second converter circuit 72 to operate as the inverter, the charging and power feeding controller 85 starts to cause the first converter circuit 71 to operate as the PFC converter. Accordingly, when the control mode is shifted from the power feeding mode to the power feeding during charging mode, it is possible to continue the power feeding to the external AC load EL and start charging to the high-voltage battery B while suppressing occurrence of UV and OV as explained above.

(7) When the control mode is shifted from the power feeding during charging mode to the power feeding mode, while continuously causing the second converter circuit 72 to operate as the inverter, the charging and power feeding controller 85 stops the operation of the first converter circuit 71, which has been caused to operate as the PFC converter. Accordingly, when the control mode is shifted from the power feeding during charging mode to the power feeding mode, it is possible to continue the power feeding to the external AC load EL and stop the charging to the high-voltage battery B while suppressing occurrence of UV and OV as explained above.

(8) From when the charging and power feeding request is acquired until the operation target of the bulk voltage control is switched from the operation target before switching to the operation target after switching, the charging and power feeding controller 85 operates the operation target before switching to thereby boost the bulk voltage by the predetermined amount from the point in time when the charging and power feeding request is acquired. Accordingly, at the switching time of the control mode, the bulk voltage at the time when the voltage control using the operation target before switching is stopped can be moved away from the lower limit threshold. Therefore, it is possible to suppress occurrence of UV from when the bulk voltage control using the operation target before switching is stopped until the bulk voltage control using the operation target after switching is started. From when the charging and power feeding request is acquired until the operation target of the bulk voltage control is switched from the operation target before switching to the operation target after switching, the charging and power feeding controller 85 operates the operation target before switching to thereby step down the bulk voltage by the predetermined amount from the point in time when the charging and power feeding request is acquired. Accordingly, at the switching time of the control mode, the bulk voltage at the time when the bulk voltage control using the operation target after switching is started can be moved away from the upper limit threshold. Therefore, it is possible to suppress occurrence of OV immediately after the bulk voltage control using the operation target after switching is started.

(9) The charging and power feeding controller 85 operates, in the bulk voltage control, the operation target such that the bulk voltage reaches the bulk voltage target value set by the bulk voltage target value setter 86. From when the charging and power feeding request is acquired until the operation target is switched from the operation target before switching to the operation target after switching, the bulk voltage target value setter 86 raises or lowers the bulk voltage target value by the predetermined offset value from the point in time when the charging and power feeding request is acquired. Accordingly, it is possible to suppress occurrence of UV and OV at the switching time of the control mode.

(10) When the control mode is switched between the power feeding mode and the charging and power feeding mode, that is, when the power feeding to the external AC load EL is continued before and after the switching of the control mode, a change amount of the bulk voltage during a period in which the bulk voltage control is temporarily stopped differs depending on the magnitude of the power feeding current. Therefore, when the control mode is switched between the power feeding mode and the power feeding during charging mode, the bulk voltage target value setter 86 changes the offset value according to the power feeding current to the external AC load EL. Accordingly, it is possible to set the offset value to appropriate magnitude taking into account a change in the bulk voltage while the bulk voltage control is temporarily stopped. Therefore, it is possible to more surely suppress occurrence of UV and OV when the control mode is switched between the power feeding mode and the charging and power feeding mode.

The embodiment of the present invention is explained above. However, the present invention is not limited to the embodiment. The detailed configuration may be changed as appropriate within the scope of the gist of the present invention.

For example, in the embodiment explained above, the four switching legs 61 to 64 in total are included in the power converter 6, the first converter circuit 71 is configured by the two switching legs 61 and 64, and the second converter circuit 72 is configured by the two switching legs 62 and 63. However, the present invention is not limited to this. The first converter circuit 71 may be configured by two or more switching legs. The second converter circuit 72 may be configured by one or more switching legs. Note that, even when the number of switching legs configuring the second converter circuit 72 is one, it is preferable that another leg is a rectifier circuit.

In the embodiment explained above, the case in which the single-phase two-line type external AC power supply EP is connected to the inlet 4 is mainly explained. However, the present invention is not limited to this. As explained with reference to FIG. 2, the three-phase four-line type external AC power supply EP′ may be connected to the inlet 4. At this time, when the three voltage lines EL1, EL2, and EL3 and the neutral line EN of the external AC power supply EP′ are respectively connected to the power lines L1, L2, L3, and N1, under the charging mode, three-phase AC power can be supplied to the power converter 6 to charge the high-voltage battery B. However, under the power feeding during charging mode, while the three-phase AC power is supplied to the power converter 6, power cannot be simultaneously fed to the external AC load EL. However, under the power feeding during charging mode, by using only the two power lines L1 and N1, it is possible to simultaneously feed power to the external AC load EL while supplying the single-phase AC power from the external AC power supply EP′ to the power converter 6.

What is claimed is:

1. A power system comprising:
an electrical storage device;
a voltage converter connected to the electrical storage device;
an inlet to which an external power supply is connectable;
an outlet to which an external load is connectable;
a power converter connected to the inlet and the outlet;
a bulk capacitor included in a power line that connects the voltage converter and the power converter; and
a control device configured to operate the voltage converter and the power converter under any one control mode among a charging mode for charging the electrical storage device with the external power supply, a power feeding mode for feeding power to the external load, and a power feeding during charging mode for feeding power to the external load while charging the electrical storage device, wherein
the control device includes:
a charging and power feeding request acquirer configured to acquire a charging and power feeding request for charging to the electrical storage device or power feeding to the external load; and
a charging and power feeding controller configured to operate the voltage converter to thereby perform voltage control for a bulk voltage, which is a voltage of the bulk capacitor, under the power feeding mode and operate the power converter to thereby perform the voltage control under the charging mode and the power feeding during charging mode, and
when the control mode is switched between the power feeding mode and the power feeding during charging mode according to the charging and power feeding request being acquired, from when the charging and power feeding request is acquired until an operation target of the voltage control is switched between the voltage converter and the power converter, the charging and power feeding controller boosts or steps down the bulk voltage by a predetermined amount from a point in time when the charging and power feeding request is acquired.

2. The power system according to claim 1, wherein
the power converter includes:
a first converter circuit including two or more switching legs connected to the power line;
a second converter circuit including one or more switching legs connected to the power line to be parallel to the first converter circuit; and
a switch circuit that is switchable between a first connection state in which both of the first and second converter circuits are connected to the inlet and a second connection state in which the first and second converter circuits are respectively connected to the inlet and the outlet,
the control device further includes a switch controller configured to switch the switch circuit to the first connection state under the charging mode and switch the switch circuit to the second connection state under the power feeding mode and the power feeding during charging mode,
the charging and power feeding controller
performs the voltage control by causing a full PFC circuit configured by the first and second converter circuits to operate as a PFC converter including the inlet on an input side under the charging mode,
performs the voltage control by operating the voltage converter under the power feeding mode, and
performs the voltage control by causing a half PFC circuit configured by the first converter circuit to operate as the PFC converter under the power feeding during charging mode, and
when the control mode is switched between the charging mode and the power feeding during charging mode according to the charging and power feeding request being acquired, from when the charging and power feeding request is acquired until the operation target is switched between the full PFC circuit and the half PFC circuit, the charging and power feeding controller boosts or steps down the bulk voltage by the predetermined amount from the point in time when the charging and power feeding request is acquired.

3. The power system according to claim 2, wherein
the charging and power feeding controller
performs the voltage control by causing the full PFC circuit to operate as the PFC converter and performs charging current control for the electrical storage device by simultaneously operating the voltage converter under the charging mode,
performs the voltage control by operating the voltage converter and performs power feeding current control for the external load by simultaneously causing the second converter circuit to operate as an inverter including the bulk capacitor on an input side under the power feeding mode, and
performs the voltage control by causing the half PFC circuit to operate as the PFC converter, performs the power feeding current control by causing the second converter circuit to operate as the inverter, and performs the charging current control by simultaneously operating the voltage converter under the power feeding during charging mode.

4. The power system according to claim 3, wherein, when the control mode is shifted from the charging mode to the power feeding during charging mode, the charging and power feeding controller starts to cause the second converter circuit to operate as the inverter while continuously causing the first converter circuit to operate as the PFC converter.

5. The power system according to claim 3, wherein, when the control mode is shifted from the power feeding during charging mode to the charging mode, the charging and power feeding controller starts to cause the second converter circuit to operate as the PFC converter while continuously causing the first converter circuit to operate as the PFC converter.

6. The power system according to claim 3, wherein, when the control mode is shifted from the power feeding mode to the power feeding during charging mode, the charging and power feeding controller starts to cause the first converter circuit to operate as the PFC converter while continuously causing the second converter circuit to operate as the inverter.

7. The power system according to claim 3, wherein, when the control mode is shifted from the power feeding during charging mode to the power feeding mode, the charging and power feeding controller stops operation of the first converter circuit while continuously causing the second converter circuit to operate as the inverter.

8. The power system according to claim 1, wherein, when the operation target before the control mode is switched and the operation target after the control mode is switched are respectively defined as an operation target before switching and an operation target after switching, from when the charging and power feeding request is acquired until the operation target is switched from the operation target before switching to the operation target after switching, the charging and power feeding controller operates the operation target before switching to thereby boost or step down the bulk voltage by the predetermined amount from the point in time when the charging and power feeding request is acquired.

9. The power system according to claim 8, wherein
the control device further includes a target value setter configured to set a bulk voltage target value in the voltage control,
the charging and power feeding controller operates the operation target such that the bulk voltage reaches the bulk voltage target value in the voltage control, and
from when the charging and power feeding request is acquired until the operation target is switched from the operation target before switching to the operation target after switching, the target value setter raises and lowers the bulk voltage target value by a predetermined offset value from the point in time when the charging and power feeding request is acquired.

10. The power system according to claim 9, wherein
the control device further includes a power feeding current acquirer configured to acquire a power feeding current to the external load, and
when the control mode is switched between the power feeding mode and the power feeding during charging mode, the target value setter changes the offset value according to the power feeding current.
